(19) United States
(12) Patent Application Publication
(10) Pub. No.: US 2015/0052233 A1
(43) Pub. Date: Feb. 19, 2015

(54) NETWORK DESIGN APPARATUS, NETWORK DESIGN METHOD, AND RECORDING MEDIUM

(71) Applicant: FUJITSU LIMITED, Kawasaki-shi (JP)

(72) Inventors: Yutaka Takita, Kawasaki (JP); Tomohiro Hashiguchi, Inagi (JP); Kazuyuki Tajima, Yokosuka (JP)

(73) Assignee: Fujitsu Limited, Kawasaki (JP)

(21) Appl. No.: 14/306,420

(22) Filed: Jun. 17, 2014

(30) Foreign Application Priority Data
Aug. 13, 2013 (JP) 2013-168342

(51) Int. Cl. H04L 12/24

(52) U.S. Cl. CPC H04L 41/145
USPC 709/223

(57) ABSTRACT

A network design apparatus includes a first processing unit configured to determine a communication route that connects predetermined nodes by selecting one or more paths provided between the nodes in a network, and to perform an estimation of communication lines opened in each of the selected one or more paths; a second processing unit configured to perform an estimation of communication apparatuses constituting the communication line and a housing that accommodates the communication apparatuses, for each node in the network, based on an estimation result of the first processing unit; and a third processing unit configured to determine whether there is a possibility of reduction in the number of the housings due to a change in the communication line, for each node in the network, based on respective estimation results of the first processing unit and the second processing unit.

### CROSS-REFERENCE TO RELATED APPLICATION

This application is based upon and claims the benefit of priority of the prior Japanese Patent Application No. 2013-168342 filed on Aug. 13, 2013 the entire contents of which are incorporated herein by reference.

### FIELD

The embodiments discussed herein are related to a network design apparatus, a network design method, and a recording medium.

### BACKGROUND

With an increase in demand for communication, high-speed optical transmission systems have been standardized. For example, the International Telecommunication Union Telecommunication Standardization Sector (ITU-T) recommendation G. 709 defines an Optical Transport Network (OTN) technology of about 2.5 to 100 (Gbps).

The optical transmission by the OTN allows large capacity transmission by multiplexing a plurality of optical signals each containing user signals, using a wavelength division multiplexing (WDM) technology. Client signals contained in the optical signals include a synchronous digital hierarchy (SDH) frame, a Synchronous Optical NETwork (SONET) frame, and Ethernet (registered trademark, the same applies hereinafter) frame.

In a wavelength division multiplexing transmission device (hereinafter, referred to as a WDM device) according to the WDM technology, an optical transceiver, which is referred to as a transponder, is provided for each communication line, and a plurality of optical signals are respectively input and output through a plurality of optical transceivers. The WDM device transmits, to another apparatus, a wavelength multiplexed optical signal obtained by multiplexing the optical signal which is input from the optical transceiver with the optical signal which is input from another node. In this specification, the input of the optical signal from the optical transceiver at this time is referred to as “insertion”.

In addition, the WDM device separates an optical signal of a predetermined wavelength from the wavelength multiplexed optical signal from another device, and receives the separated optical signal by the optical transceiver. In this specification, the separation of the optical signal at this time is referred to as “branching”.

The main cost of a network that is configured by the WDM device is affected by the number of communication lines opened in the path within the network, and the number of shelves (housing) that are provided at each node within the network and house the optical transceivers. The cost of the communication line includes the cost of a pair of the optical transceivers for performing the communication. In addition, the cost of the shelf also includes the cost of the floor area of the station occupied by a rack on which the shelf is mounted, as well as the cost of the shelf itself.

Accordingly, in a network design, a communication line design and a line accommodation design of a shelf are performed based on traffic demand between nodes. In the communication line design, each piece of traffic is assigned to a communication line such that the bandwidth of each piece of traffic is efficiently included in the bandwidth of a communication line opened in a path within a network. In this regard, for example, Japanese Laid-open Patent Publication No. 2013-90297 discusses a technology that performs a design of a communication line such that the cost of the communication line is minimized, by solving an integer programming problem.

In addition, in the line accommodation design of the shelf, optical transceivers constituting a communication line are assigned to a shelf such that the optical transceivers are accommodated efficiently in the shelf of each node. In this regard, for example, Japanese Laid-open Patent Publication No. 5-252133 discusses designing of the mounting state in the housing by calculating the type and number of a fit package of a line and a terminal, a shelf, and a housing from the basic information of the network.

In order to design a network of low cost, it is desirable to take into account both the communication line and the shelf. In this case, for example, performing a network design in which the communication line design is performed and then an accommodation design of a shelf is performed for each node based on the result of the design is considered.

However, according to this design method, since it is difficult to reflect the result of the accommodation design of the shelf on the communication line design, it is difficult to obtain a result of a design in which both the number of the communication lines and the number of shelves are optimized.

Therefore, performing the network design using a model of the integer programming method generated by integrating parameters and constraint conditions of the communication line design and the accommodation design of shelf is considered. According to this design method, although it is possible to optimize the number of communication lines and the number of shelves in principle, it is difficult to derive a solution within a practical time, because the model is large-scale.

### SUMMARY

According to an aspect of the embodiments, a network design apparatus includes: a first processing unit configured to determine a communication route that connects predetermined nodes by selecting one or more paths provided between the nodes in a network, in response to traffic demand between the predetermined nodes in the network, and to perform an estimation of communication lines opened in each of the selected one or more paths; a second processing unit configured to perform an estimation of communication apparatuses constituting the communication line and a housing that accommodates the communication apparatuses, for each node in the network, based on an estimation result of the first processing unit; and a third processing unit configured to determine whether there is a possibility of reduction in the number of the housings due to a change in the communication line, for each node in the network, based on respective estimation results of the first processing unit and the second processing unit, wherein the third processing unit generates a constraint condition that causes the reduction in the number of the housings, based on a first upper limit number of the communication line, for each node, when the third processing unit determined that there is the possibility of reduction in the number of the housings, wherein the first processing unit performs again the estimation of the communication line according to the constraint condition based on the first upper limit number, and wherein the second processing unit performs again the estimation of the communication apparatuses and the housing, based on the result of the estimation that is performed again by the first processing unit.

The object and advantages of the invention will be realized and attained by means of the elements and combinations particularly pointed out in the claims.

It is to be understood that both the Foregoing general description and the following detailed description are exemplary and explanatory and are not restrictive of the invention, as claimed.

### BRIEF DESCRIPTION OF DRAWINGS

FIG. 1 is a configuration diagram illustrating an example of a network;

FIG. 2 is a configuration diagram illustrating a configuration example of an optical signal;

FIG. 3 is a configuration diagram illustrating an example of a functional configuration of a WDM device;

FIG. 4 is a configuration diagram illustrating an example of a mounting configuration of the WDM device;

FIG. 5 is a configuration diagram illustrating an example of a network design apparatus according to an embodiment;

FIG. 6 is a configuration diagram illustrating a functional configuration of a central processing unit (CPU) and an example of information stored by a hard disk drive (HDD);

FIG. 7 is a flow chart illustrating a network design method according to the embodiment;

FIG. 8 is a flow chart illustrating a process of communication line design;

FIG. 9 is a diagram illustrating an example of paths provided in a network;

FIG. 10 is a diagram illustrating communication route candidates configured with paths;

FIG. 11 is a diagram illustrating examples of communication lines which are opened in paths constituting a communication route;

FIG. 12 is a table illustrating contents of variables used in a model of an integer programming problem constructed by a first processing unit;

FIG. 13 is a flow chart illustrating a determination process of a possibility of reduction in the number of shelves;

FIG. 14 is a configuration diagram illustrating an example of a mounting state of a WDM device;

FIG. 15 is a configuration diagram illustrating an example of a mounting state of the WDM device when the communication line is changed;

FIG. 16 is a flow chart illustrating a determination process of increase risk of the number of shelves;

FIG. 17 is a table illustrating contents of variables used in a constraint equation generated by a third processing unit;

FIG. 18 is a diagram illustrating a result of a communication line design of a first comparative example;

FIGS. 19A and 19B are diagrams illustrating a result of a line accommodation design of a shelf of the first comparative example;

FIG. 20 is a diagram illustrating a result of a communication line design of a second comparative example;

FIGS. 21A and 21B are diagrams illustrating a result of a line accommodation design of a shelf of the second comparative example;

FIG. 22 is a diagram illustrating a result of a communication line design of the embodiment;

FIGS. 23A and 23B are diagrams illustrating a result of a line accommodation design of a shelf of the embodiment;

FIG. 24 is a table comparing the second comparative example and the embodiment; and

FIG. 25 is a table illustrating contents of variables used in FIG. 24.

### DESCRIPTION OF EMBODIMENTS

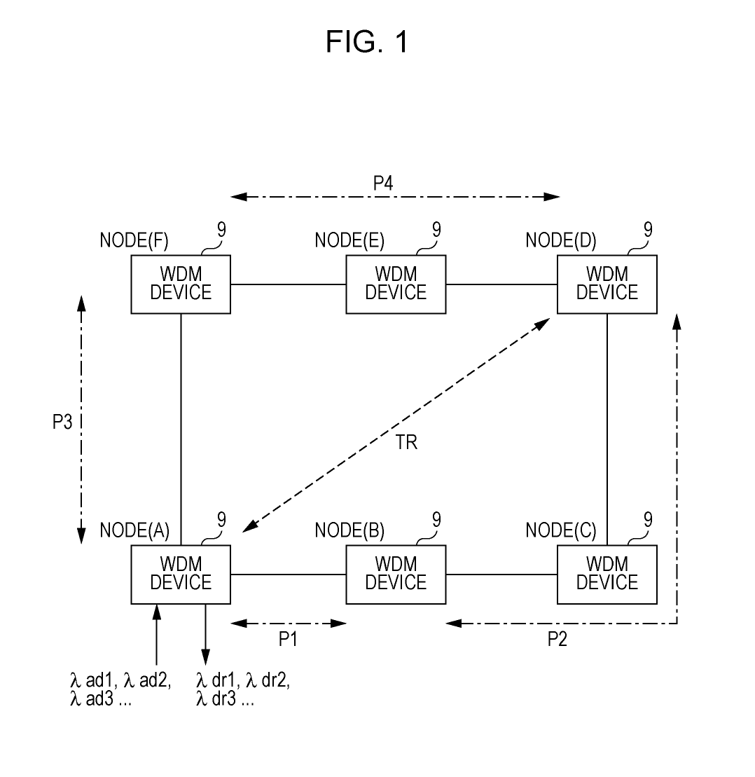

FIG. 1 is a configuration diagram illustrating an example of a network. This network is an example of a network to be designed. The network includes nodes (A) to (F) in which each WDM device 9 is provided. The WDM devices 9 of the nodes (A) to (F) are connected in a ring shape through an optical fiber which is a transmission path. In addition, although in the present embodiment, the network shape is the ring shape, without being limited thereto, and the network shape may be, for example, a mesh shape.

The WDM device 9 multiplexes optical signals having a plurality of different wavelengths λad1, λad2, λad3, . . . and transmits the multiplexed optical signal to the WDM device 9 in an adjacent node. The WDM device 9 separates the optical signals having a plurality of different wavelengths λdr1, λdr2, λdr3, . . . from the multiplexed optical signal which is received from the another node and outputs the separated optical signals to a network on a client side. Accordingly, it is possible to insert an optical signal of a certain wavelength to a certain node and to cause the optical signal of a certain wavelength to branch from another node, in the network.

In a design of a network, depending on demanded traffic TR between predetermined nodes in the network, a communication route connecting the nodes is determined. In this example, the traffic TR is demanded, for example, between the node (A) and the node (D) (see the dashed line).

In this network, for example, it is assumed that paths P1 to P4 are provided (see the dash-dotted line). The paths P1 to P4 are a transmission route through which the optical signal of a predetermined wavelength is transmitted from when the optical signal is inserted to the WDM device 9 until the optical signal branches from another WDM device 9. The path P1 is provided between the node (A) and the node (B), the path P2 is provided between the node (B) and the node (D), the path P3 is provided between the node (A) and the node (F), and the path P4 is provided between the node (F) and the node (D).

The communication route according to the demanded traffic is determined by selecting one or more paths. In the present example, as the communication route candidate, there are a route including the path P1 and path P2 and a route including the path P3 and the path P4.

If a communication route is determined in a network design, an estimation of communication lines opened in each of the selected paths P1 to P4 is performed. For example, if it is assumed that a transmission direction is a direction from the node (A) to the node (B), the communication line of the path P1 is opened by setting such that an optical signal having a predetermined wavelength is inserted into the WDM device 9 of the node (A) and branches from the WDM device 9 of the node (B) through the WDM device 9 of the node (C). If it is assumed that a transmission direction is a direction from the node (B) to the node (D), the communication line of the path P2 is opened by setting such that an optical signal having a predetermined wavelength is inserted into the WDM device 9 of the node (B) and branches from the WDM device 9 of the node (D). In addition, in the following description, as the case of the node (C), the passing of the optical signal through the WDM device 9 of a node without being inserted or branching is referred to as “through”.

When the route including the path P1 and path P2 is selected as the communication route according to the traffic TR, the communication line is switched from the communication line opened in the path P1 to the communication line opened in the path P2, in the node (B). Switching the communication line in this manner is referred to as “grooming” in the following description.

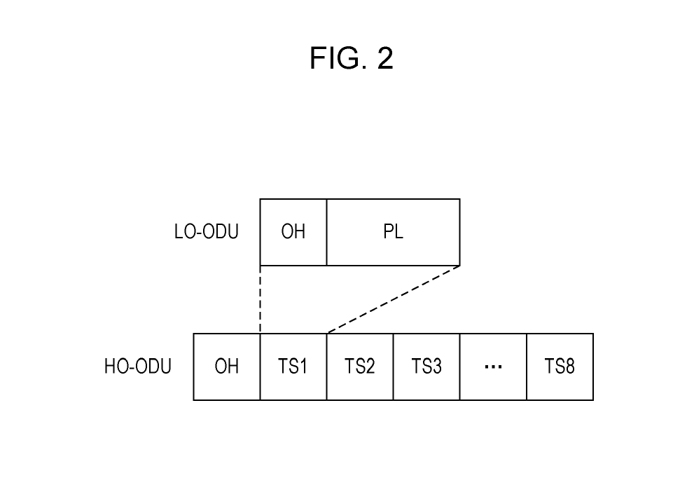

FIG. 2 is a configuration diagram illustrating a configuration example of an optical signal. The optical signal has a configuration of a higher order optical channel data unit (HO-ODU) defined in the ITU-T recommendation G.709 as an example. The HO-ODU has an overhead OH including predetermined control information and tributary slots (TS) 1 to TS8 which are logical channels.

There are a plurality of types of transmission speeds in the HO-ODU. ITU-T recommendation G.709 defines “ODU0” of 1.25 (Gbps), “ODU1” of 5 (Gbps), “ODU2” of 10 (Gbps), “ODU3” of 40 (Gbps), and “ODU4” of 100 (Gbps).

The HO-ODU has TSs according to the transmission speed, that is, bandwidth. For example, the number of TSs is 8 when the bandwidth is “ODU2”, and 2 when the bandwidth is “ODU1”. Further, the bandwidths of TS1 to TS8 are each 1.25 (Gbps) (that is, bandwidth of ODU0). In addition, the type of the “ODU(n)” (n is a natural number) is denoted by “type of bandwidth” in the following description.

The TS1 to TS8 respectively accommodate lower order ODU (LO-ODU). LO-ODU includes an overhead OH including predetermined control information and a payload PL. The payload PL accommodates a client signal such as a SDH frame, a SONET frame, and an Ethernet frame. As the bandwidth of the client signal, there are, for example, 1.25 (Gbps), 2.5 (Gbps), and 10 (Gbps).

Accordingly, the HO-ODU can accommodate a plurality of client signals by multiplexing a plurality of LO-ODUs. The bandwidth of the demanded traffic is given as the bandwidth of the client signal. In addition, in the present specification, OTN defined in the ITU-T recommendation G.709 is exemplified as the transmission method of an optical signal, but is not limited thereto.

Further, the bandwidth of the communication line opened in a path includes a plurality of types of bandwidths according to the type of bandwidth of the HO-ODU. The type of the bandwidth of the communication line affects the cost of the optical transceiver that transceives the HO-ODU. Therefore, in a network design, the type and the number of bandwidths of the communication line are estimated such that the cost of the communication line used in the entire network is minimized. In addition, in the present embodiment, the type of the bandwidth of the communication line includes only 10 (Gbps) (corresponding to ODU2) and 100 (Gbps) (corresponding to ODU4), but is not limited thereto.

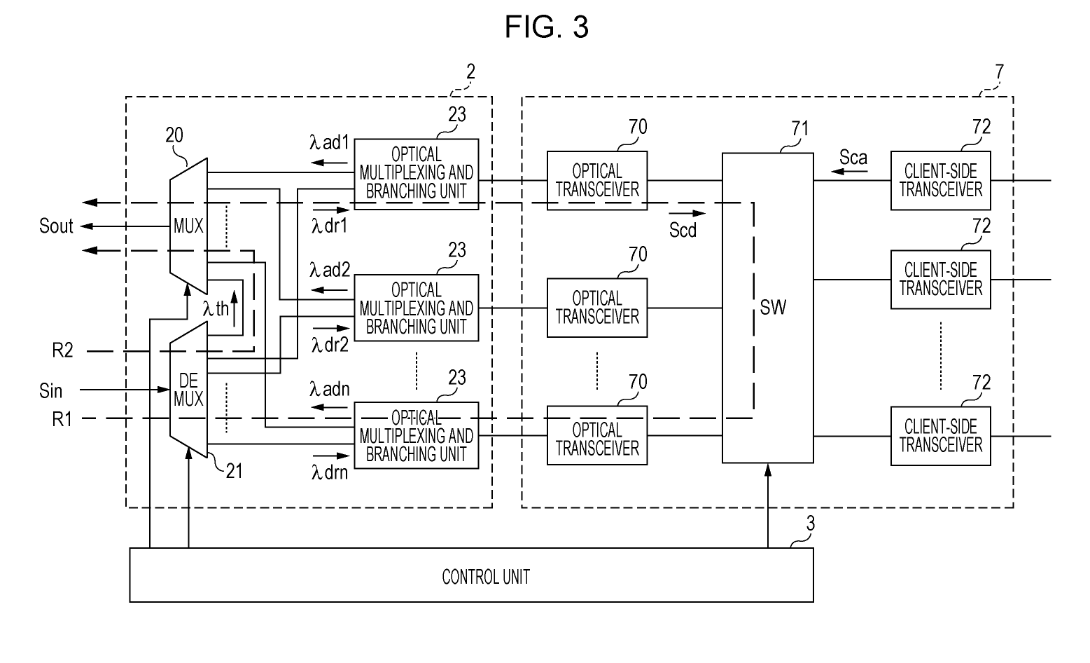

FIG. 3 is a configuration diagram illustrating an example of a functional configuration of the WDM device 9. The WDM device 9 includes a cross-connect unit 7, an optical demultiplexer 2, and a control unit 3.

The cross-connect unit 7 performs a conversion and a switching between a client signal and the HO-ODU (that is, an optical signal). The cross-connect unit 7 includes a plurality of optical transceivers 70, a switch 71, and a plurality of the client-side transceivers 72.

The client-side transceiver 72 outputs a client signal Sca received from a client-side network to the switch 71. The switch 71 outputs the client signal Sca to the optical transceiver 70 according to the setting from the control unit 3.

The plurality of optical transceivers 70 input and output a plurality of optical signals having different wavelengths with the optical demultiplexer 2. The optical transceiver 70 accommodates the client signal Sca which is input from the switch 71 in the HO-ODU, and converts the client signal Sca into an optical signal so as to output the optical signal to the optical demultiplexer 2.

Further, the optical transceiver 70 converts the optical signal which is input from the optical demultiplexer 2 into an electrical signal and extracts a client signal Scd from the HO-ODU so as to output the client signal Scd to the switch 71. The switch 71 outputs the client signal Scd to the client-side transceiver 72 according to the setting from the control unit 3. The client-side transceiver 72 transmits the client signal Scd which is input from the switch 71 to the client-side network.

According to the setting from the control unit 3, the switch 71 exchanges client signals Sca and Scd between a plurality of optical transceivers 70 and a plurality of the client-side transceivers 72. Further, when the setting of “grooming” is performed, the switch 71 returns the client signal Scd which is input from the optical transceiver 70 to another optical transceiver 70 (see the route R1).

The optical demultiplexer 2 separates a multiplexed optical signal which is transmitted from an adjacent node in a unit of a wavelength and wavelength-multiplexes the optical signal to be transmitted to the adjacent node so as to output a multiplexed optical signal to a transmission path. The optical demultiplexer 2 includes a multiplexer (MUX) 20, a demultiplexer (DEMUX) 21, and a plurality of optical multiplexing and branching units 23.

According to the setting from the control unit 3, the DEMUX 21 separates a multiplexed optical signal Sin which is transmitted from an adjacent node, as an optical signal for each wavelength, and outputs optical signals having the wavelengths λdr1 to λdrn, to which a “branching” setting has been given, to the optical multiplexing and branching unit 23. Further, the DEMUX 21 outputs the optical signals having one or more wavelengths λth, to which a “through” setting has been given, to the MUX 20. Although, for example, a wavelength selection switch is used as the DEMUX 21, without being limited thereto, other optical devices such as array waveguide grating may be used.

According to the setting from the control unit 3, the MUX 20 multiplexes the optical signals having the wavelengths λad1 to λadn, to which an “insertion” setting has been given, and transmits the multiplexed signals to the adjacent node, and thus the multiplexed signals are output to the transmission path as the multiplexed optical signal Sout. The optical signals having the wavelengths λad1 to λadn are respectively input from a plurality of optical multiplexing and branching units 23 to the MUX 20.

In addition, although one MUX 20 and one DEMUX 21 are illustrated in FIG. 3, actually, they are provided for each route (a transmission path between adjacent nodes). In the example of FIG. 1, the node (A) is adjacent to the node (B) and the node (F), and two MUXs 20 and two DEMUXs 21 are provided in the WDM device 9 of the node (A).

The plurality of optical multiplexing and branching units 23 respectively output the optical signals having the wavelengths λdr1 to λdrn which are input from the DEMUX 21 to the plurality of optical transceivers 70. Further, the plurality of optical multiplexing and branching units 23 output the optical signals having the wavelengths λad1 to λadn which are input from the plurality of optical transceivers 70 to the MUX 20. Although for example, a WDM coupler is used as the optical multiplexing and branching unit 23, without being limited thereto, other optical devices such as an optical circulator may be used.

According to this configuration, the optical signals to branch are separated from the multiplexed optical signal by the DEMUX 21, and are input to the optical transceiver 70 through the optical multiplexing and branching unit 23. In the end point nodes of the demanded traffic (in the case of FIG. 1, node (A) and node (D)), the optical signals to branch are input to the client-side transceiver 72 through the switch 71 and then transmitted to the client-side network.

Meanwhile, the optical signals to be inserted are input from the optical transceiver 70 to the MUX 20 through the optical multiplexing and branching unit 23. In the end point nodes of the demanded traffic, the optical signals to be inserted are input to the optical transceiver 70 from the client-side transceiver 72 through the switch 71.

When the “grooming” is performed, the client signal passes through the route R1 illustrated in FIG. 3. That is, the optical signal accommodating the client signal subjected to the “grooming”, as a branch object, is input to the optical transceiver 70 through the DEMUX 21 and optical multiplexing and branching unit 23. After the client signal is extracted from the HO-ODU and input to the switch 71, the client signal is returned in the switch 71 and input to the other optical transceiver 70. In addition, when the wavelength of the optical signal is not changed, the switch 71 may return the client signal to the optical transceiver 70 of an input source.

The returned client signal is accommodated again in the HO-ODU in the optical transceiver 70, and converted into an optical signal. Then, the optical signal, as an insertion object, is input to the MUX 20 through the optical multiplexing and branching unit 23, and output to the transmission path. In this manner, when the “grooming” is performed, the optical signal branches first, and then the optical signal is inserted again. Accordingly, in this case, one or two optical transceivers 70 are used.

In contrast, when the “through” is performed, the optical signal passes through the route R2 illustrated in FIG. 3. That is, the optical signal as a through object is directly input to the MUX 20 from the DEMUX 21, while not being converted into an electrical signal by the optical transceiver 70. Accordingly, in this case, the optical transceiver 70 is not used.

The control unit 3 includes, for example, a processor such as a CPU, and sets the MUX 20, the DEMUX 21, and the switch 71. The control unit 3 acquires setting information by communicating with, for example, a network management apparatus (not illustrated).

In the station of each node, the cross-connect unit 7, the optical demultiplexer 2, and the control unit 3 are accommodated in the shelf which is a housing of the WDM device 9. There is a limit to an accommodation capacity in the shelf, and the shelf is mounted on the rack and occupies a certain floor area in the station. For this reason, a network design is performed such that the number of shelves is minimized in consideration of the accommodation efficiency of the shelf, and thus the cost of the network is reduced.

In the present embodiment, the accommodation design of the cross-connect unit 7 among the cross-connect unit 7, the optical demultiplexer 2, and the control unit 3 is performed. Since the optical transceiver 70 is provided according to the communication line opened in the path, the cross-connect unit 7 significantly affects the number of shelves.

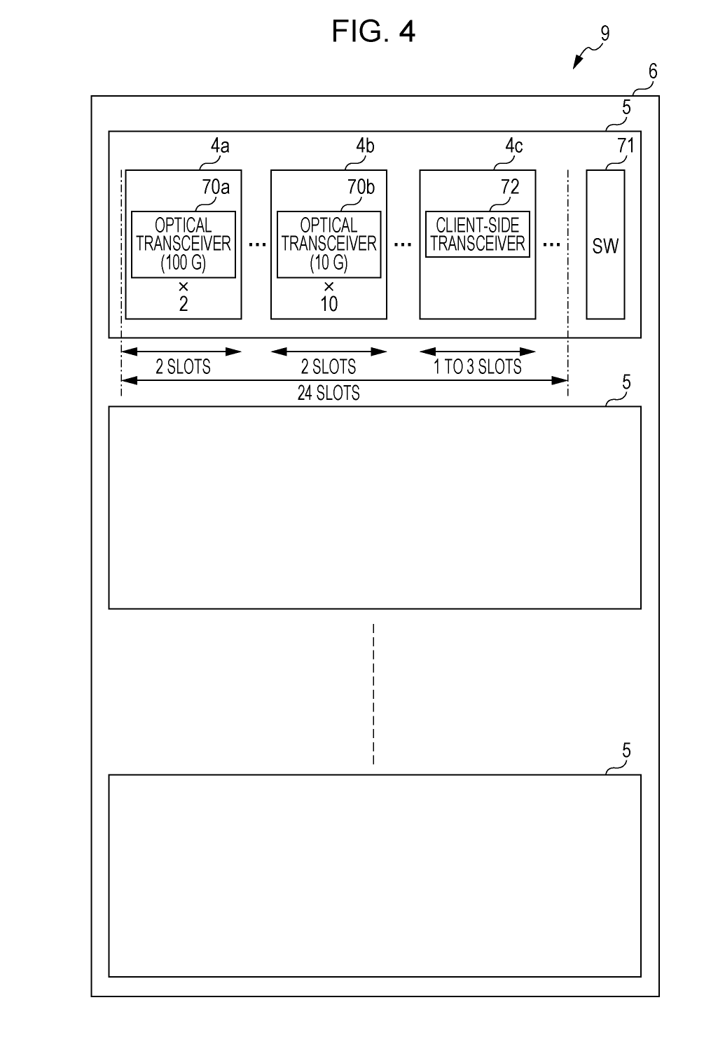

FIG. 4 is a configuration diagram illustrating an example of a mounting configuration of the WDM device 9. More specifically, FIG. 4 illustrates the mounting configuration of the cross-connect unit 7.

The rack 6 is equipped with one or more shelves 5. The shelf 5 accommodates the first to third communication units 4a to 4c and the switch 71. Since the shelf 5 accommodates the first to third communication units 4a to 4c, for example, 24 slots are provided. The first to third communication units 4a to 4c are respectively electronic circuit boards in which electronic components are implemented, and are accommodated in the shelf 5 by being inserted into the slots.

Optical transceivers 70a and 70b are respectively implemented in the first and second communication units (communication apparatuses) 4a and 4b. For the optical transceiver 70, there are two optical transceivers 70a and 70b according to the type of the bandwidth of the HO-ODU. The optical transceiver 70a is an optical transceiver 70 corresponding to the HO-ODU of 100 (Gbps) (ODU4), and the optical transceiver 70b is an optical transceiver 70 corresponding to the HO-ODU of 10 (Gbps) (ODU2).

For example, two optical transceivers 70a are mounted in the first communication unit 4a, and two slots are used. For example, ten optical transceivers 70b are mounted in the second communication unit 4b, and two slots are used. Accordingly, the first communication unit 4a may accommodate a higher bandwidth of traffic than that in the second communication unit 4b.

For example, one client-side transceiver 72 is mounted in the third communication unit 4c, and for example, one to three slots are used according to the bandwidth of the client signal. The first to third communication units 4a to 4c share 24 slots.

The number of the first and second communication units 4a and 4b is determined according to an estimation result of the communication lines opened in the path, and affects the estimation result of the number of shelves 5 (hereinafter, referred to as “number of shelves”). In a line accommodation design of shelf 5, the estimation of the first and second communication units 4a and 4b and the shelf 5 is performed such that the number of shelves is minimized. The network design apparatus according to the embodiment performs design such that both the number of communication lines and the number of shelves are reduced by feeding the estimation result of the number of shelves back to the estimation of the communication line.

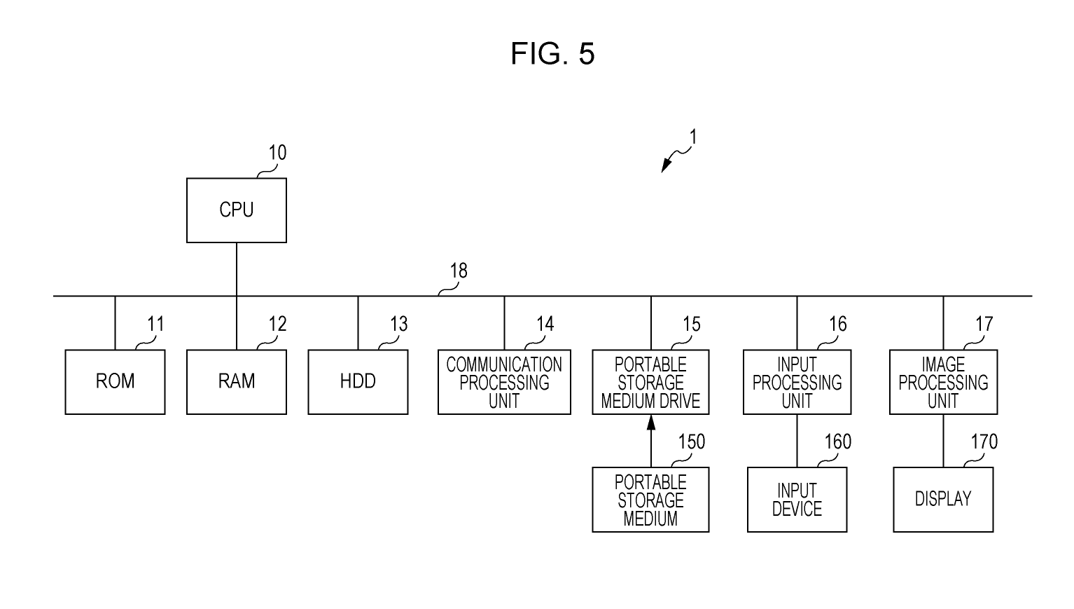

FIG. 5 is a configuration diagram illustrating an example of a network design apparatus according to the embodiment. The network design apparatus 1 is, for example, a computer apparatus such as a server. The network design apparatus 1 includes a CPU 10, a read only memory (ROM) 11, a random access memory (RAM) 12, an HDD 13, a communication processing unit 14, a portable storage medium drive 15, an input processing unit 16, an image processing unit 17, and the like.

The CPU 10 is an operation processing unit and performs a design process of a network according to a network design program. The CPU 10 is connected to respective units 11 to 17 to be able to communicate with each other through a bus 18. In addition, the network design apparatus 1 is not limited to being operated by software, and hardware such as application specific integrated circuits may be used instead of the CPU 10 as the network design apparatus 1.

The RAM 12 is used as a working memory of the CPU 10. Further, the ROM 11 and the HDD 13 are used as storage units that store a network design program to operate the CPU 10, and the like. The communication processing unit 14 is a communication unit such as a network card that performs communication with external devices through a network such as a local area network (LAN).

The portable storage medium drive 15 is a device that performs writing and reading of information with a portable storage medium 150. An example of the portable storage medium 150 includes a Universal Serial Bus (USB) memory, a Compact Disc Recordable (CD-R), a memory card, and the like.

The network design apparatus 1 further includes an input device 160 for performing an input operation of information and a display 170 for displaying an image. The input device 160 is an input unit such as a keyboard and a mouse, and input information is output to the CPU 10 through the input processing unit 16. The display 170 is an image display unit such as a liquid crystal display, and displayed image data is output to the display through the image processing unit 17 from the CPU 10. In addition, instead of the input device 160 and the display 170, a device such as a touch panel including such functions may be used.

The CPU 10 executes a program stored in the ROM 11, the HDD 13, or the like, or a program which is read by the portable storage medium drive 15 from the portable storage medium 150. The program includes also the network design program as well as an operating system (OS). In addition, the program may be downloaded through the communication processing unit 14.

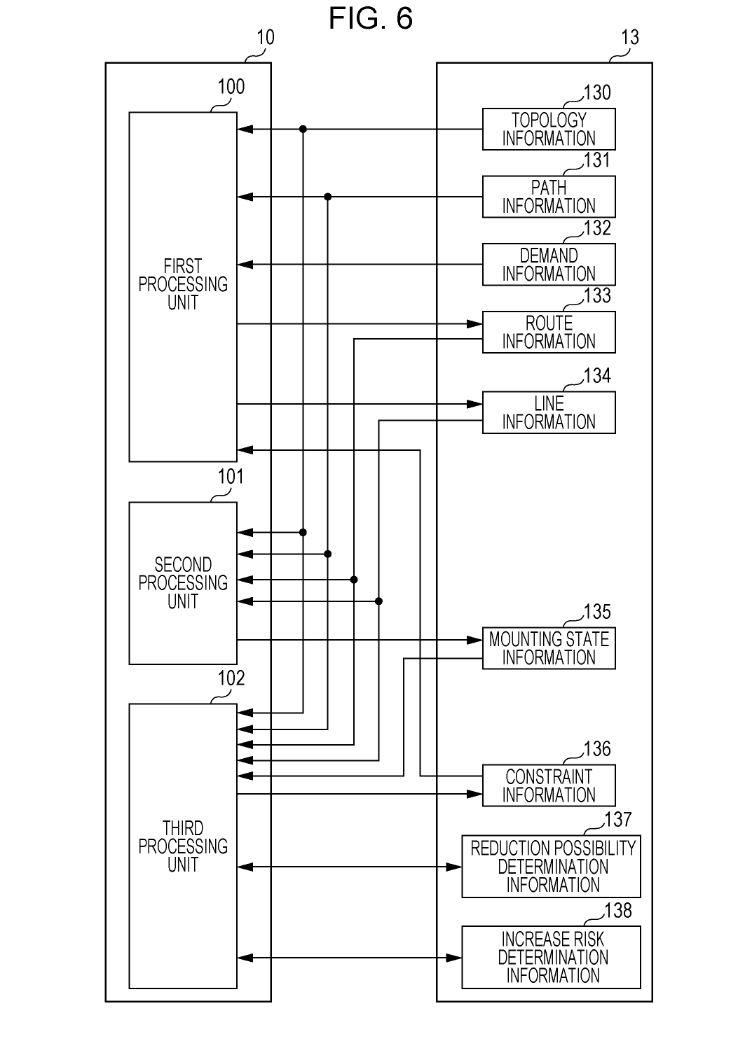

If the CPU 10 executes the network design program, a plurality of functions are made. FIG. 6 is a configuration diagram illustrating a functional configuration of the CPU 10 and an example of information stored by the HDD 13.

The CPU 10 includes a first processing unit 100, a second processing unit 101 and a third processing unit 102. In association with respective units 100 to 102, the HDD 13 stores topology information 130, path information 131, demand information 132, route information 133, line information 134, mounting state information 135, constraint information 136, reduction possibility determination information 137, and increases risk determination information 138. The storage unit of each piece of information 130 to 138 is not limited to the HDD 13, and may be the ROM 11 or the portable storage medium 150.

The topology information 130 is information indicating a form of a network to be designed as illustrated in FIG. 1, that is, a connection relationship between nodes through a link. The topology information 130 is configured by associating, for example, an identifier of each link in a network with an identifier of a pair of nodes which are connected through the link.

The path information 131 is information indicating a plurality of paths which are set in the network. The path information 131 includes, for example, identifiers of a plurality of sets of nodes indicating the end point nodes of a plurality of paths with identifiers of one or more links that link end point nodes.

The demand information 132 is information indicating a demand of a plurality of pieces of traffic for a network. The demand information 132 indicates a bandwidth used in communication between a pair of nodes in the network for each of the demanded pieces of traffic. In addition, the demand of each piece of traffic is referred to as “demand” in the following description. For example, the topology information 130, the path information 131, and the demand information 132 may be acquired from the outside through the communication processing unit 14, the portable storage medium 150, or the input device 160.

The first processing unit 100 reads the topology information 130, the path information 131, and the demand information 132 from the HDD 13, and determines a communication route in response to traffic demand based on each piece of information. At this time, the communication route is determined by selecting one or more paths provided between nodes in the network.

Further, the first processing unit 100 performs an estimation of communication lines opened in one or more paths included in the determined communication route. More specifically, the first processing unit 100 estimates the number of communication lines for each type of bandwidth (ODU2 and ODU4). The first processing unit 100 generates, as a design result, route information 133 indicating the determined communication route and the line information 134 indicating the bandwidth and the number of the estimated communication lines for each demand, and writes the generated information to the HDD 13.

The second processing unit 101 reads the topology information 130, the path information 131, the route information 133, and the line information 134 from the HDD 13, and performs the line accommodation design of the shelf 5 for each node in the network, based on each piece of information. In other words, the second processing unit 101 performs estimation of the communication units 4a and 4b constituting a communication line, and the shelf 5 that accommodates the communication units 4a and 4b for each node in the network, based on the estimation result of the first processing unit. The second processing unit 101 generates mounting state information 135 indicating the number of shelves, the number of communication units 4a to 4c, mounting state positions (slot positions), and the like as a design result and writes the generated information to the HDD 13.

The third processing unit 102 reads the topology information 130, the path information 131, the route information 133, and the mounting state information 135 from the HDD 13, and determines whether there is the possibility of reduction in the number of shelves based on each piece of information. In other words, the third processing unit 102 determines whether there is the possibility of reduction in the number of shelves due to the change in the communication line for each node in the network, based on each estimation result of the first processing unit 100 and the second processing unit 101. At this time, the third processing unit 102 generates reduction possibility determination information 137 indicating information regarding the determination process for each node, and writes the generated information to the HDD 13.

When it is determined that there is the possibility of reduction in the number of shelves, the third processing unit 102 generates a constraint condition (first constraint condition) based on the upper limit number of the communication lines which can be reduced for each node, and writes the condition as constraint information 136 to the HDD 13. At this time, the first processing unit 100 reads the constraint information 136 from the HDD 13 and performs again the estimation of the communication line according to the constraint condition based on the upper limit number, and the second processing unit performs again the estimation of the communication units 4a to 4c and the shelf 5, based on the estimation result. In this manner, the third processing unit 102 feeds the estimation result of the second processing unit 101 back to the communication line design process of the first processing unit 100.

When it is determined that the there is no possibility of reduction in the number of shelves, the third processing unit 102 determines the risk of an increase in the number of shelves due to re-execution of respective estimations of the first processing unit 100 and the second processing unit 101, for the node. At this time, the third processing unit 102 generates increase risk determination information 138 indicating information regarding the determination process for each node, and writes the generated information to the HDD 13.

Then, the third processing unit 102 generates a constraint condition based on the upper limit number (a second upper limit number) of the communication line so as not to increase the number of shelves for the node having an increase risk, and writes the generated information as the constraint information 136 to the HDD 13. At this time, the first processing unit 100 reads the constraint information 136 from the HDD 13, and performs again the estimation of the communication line according to the constraint condition based on the upper limit number, and the second processing unit performs again the estimations of the communication units 4a to 4c and the shelf 5 based on the estimation result.

Thus, re-execution of estimation by the first processing unit 100 and the second processing unit 101 does not allow the number of shelves to be increased in other nodes in which it is impossible to reduce the number of shelves.

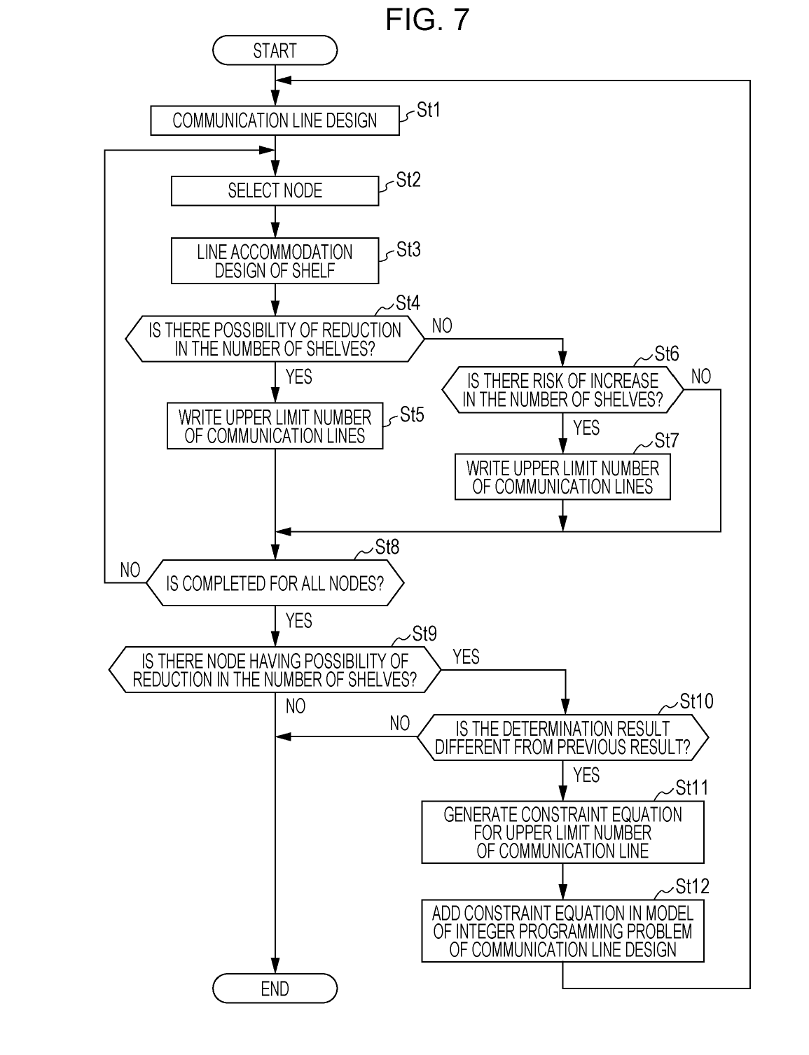

Next, the process of the CPU 10 will be described. FIG. 7 is a flow chart illustrating a network design method according to the present embodiment.

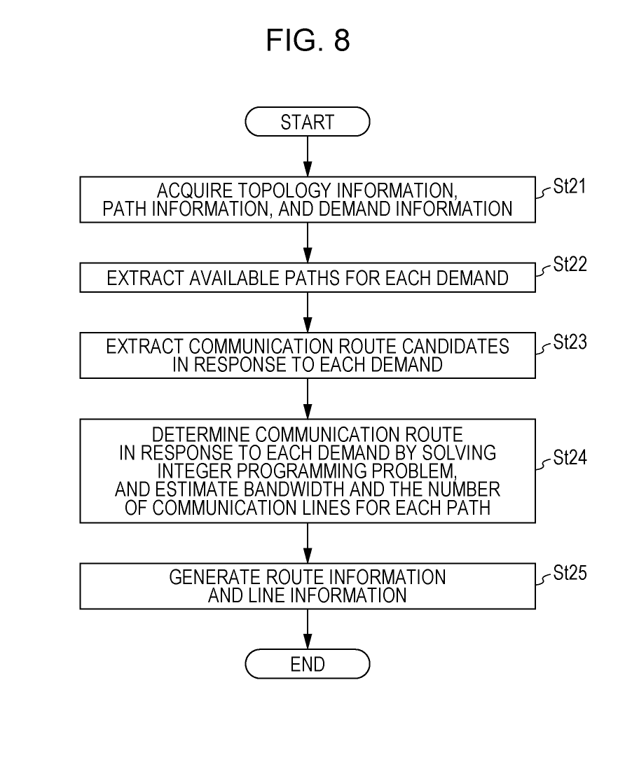

First, the first processing unit 100 performs a communication line design (step St1). FIG. 8 is a flow chart illustrating a process of communication line design. The first processing unit 100 acquires the topology information 130, the path information 131, and the demand information 132 from the HDD 13 (step St21).

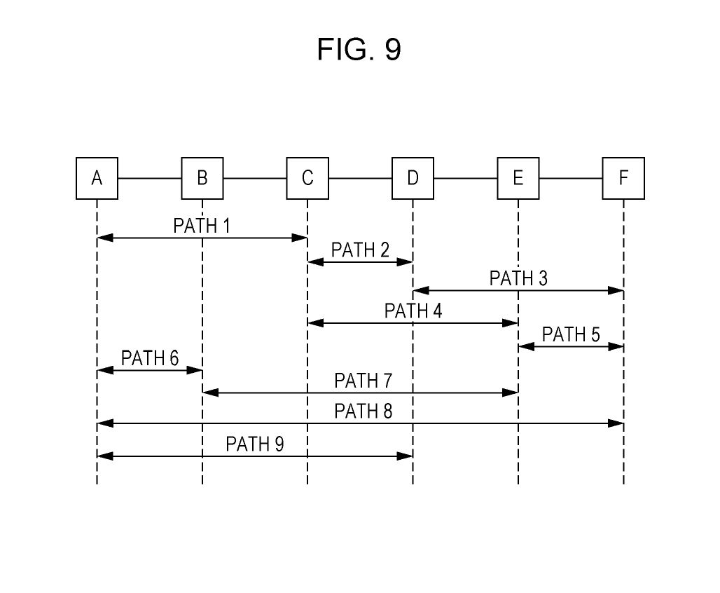

Next, the first processing unit 100 extracts available paths for each demand (step St22). FIG. 9 illustrates an example of paths provided in a network. In addition, for convenience of description, FIG. 9 illustrates a simple network in which nodes A to F are connected in series, and it is assumed that a set of nodes corresponding to the demand is the node A and the node F.

The first processing unit 100 extracts, from one or more paths provided in the network, a plurality of paths 1 to 9 present between the node A and the node F corresponding to the demand. In other words, the paths 1 to 9 are extracted as a route which can be at least a part of the communication route connecting the node A to node F. For example, the path 1 connects the node A and the node C, and the path 2 connects the node C and the node D.

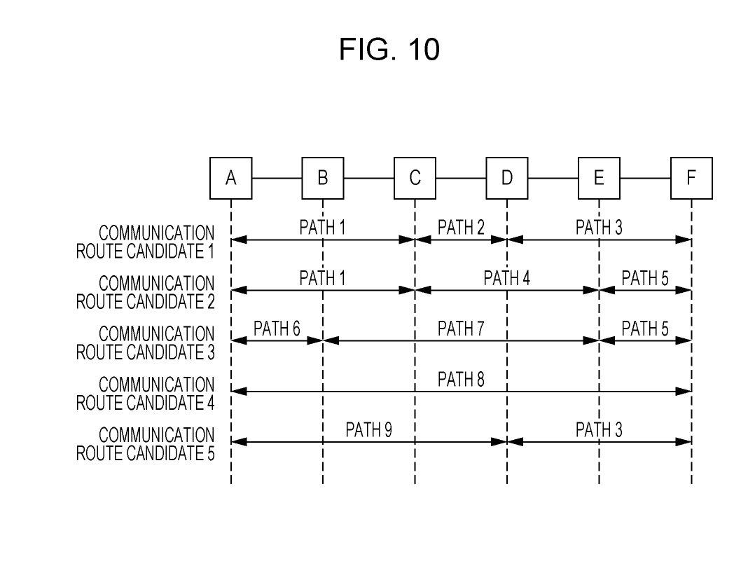

Next, the first processing unit 100 extracts communication route candidates in response to each demand by selecting one or more paths for each demand (step St23). FIG. 10 illustrates communication route candidates configured with the paths 1 to 9.

For example, the communication route candidate 1 includes the path 1, the path 2, and the path 3, and the communication route candidate 2 includes the path 1, the path 4, and the path 5. In this manner, respective communication route candidates 1 to 5 are extracted as a combination of one or more paths.

Next, the first processing unit 100 determines a communication route in response to each demand by solving an integer programming problem, and estimates the bandwidth and the number of communication lines for each path (step St24). The model of an integer programming problem constructed by the first processing unit 100 will be described later.

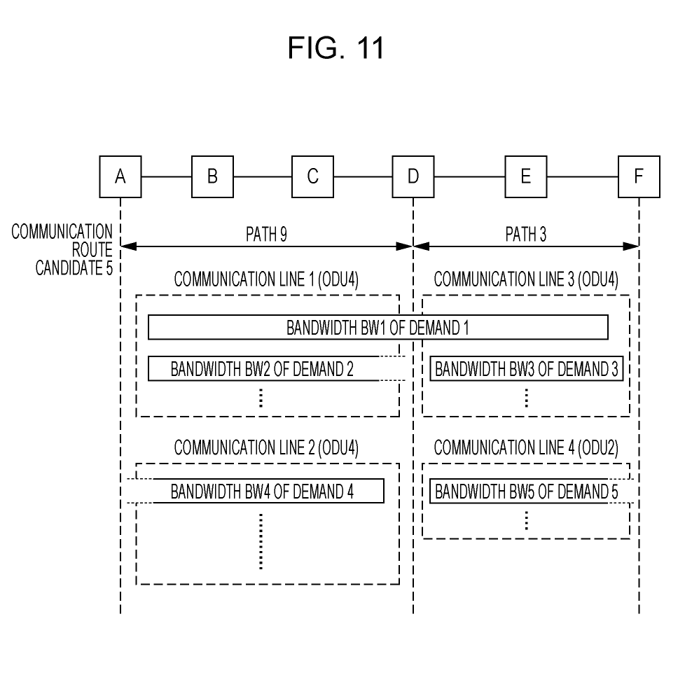

FIG. 11 illustrates examples of communication lines opened in paths constituting the communication route. In the present example, the first processing unit 100 selects the candidate 5 as the communication route in response to the demand among the communication route candidates 1 to 5 illustrated in FIG. 10. The selected communication route includes the path 9 and the path 3.

The first processing unit 100 estimates the number of communication lines which are respectively opened in the path 9 and the path 3. The estimation is performed for each bandwidth type of a communication line (ODU2 and ODU4). In this manner, it is possible to perform a flexible design in response to the demand of various bandwidths by estimating a communication line for each type of bandwidth.

The first processing unit 100 performs an estimation of a communication line such that the whole cost of the communication line in the network is minimized. For example, the cost of the communication line is determined based on the price and the maintenance cost of the communication units 4a and 4b constituting the communication line.

As the estimation result, the communication lines 1 and 2 of ODU4 are assigned to the path 9. The communication line 1 accommodates a bandwidth BW1 of a demand 1, a bandwidth BW2 of a demand 2, and the like, and the communication line 2 accommodates a bandwidth BW4 of a demand 4, and the like. Further, the communication line 3 of ODU4 and the communication line 4 of ODU2 are assigned to the path 3. The communication line 3 accommodates the bandwidth BW1 of the demand 1, a bandwidth BW3 of a demand 3, and the like, and the communication line 4 accommodates a bandwidth BW5 of a demand 5 and the like.

Next, the first processing unit 100 generates the route information 133 and the line information 134 according to the estimation result (step St25). The route information 133 indicates the communication route according to each demand as a set of one or more paths. The line information 134 indicates the bandwidth and the number of the communication lines for each path. The route information 133 and the line information 134 which are generated are used in the line accommodation design of the shelf 5 by the second processing unit 101. Thus, the first processing unit 100 performs a design process of the communication line.

Next, in the process St24 illustrated in FIG. 8, the model of an integer programming problem constructed by the first processing unit 100 will be described. The integer programming problem is a tool for obtaining a solution for maximizing or minimizing a predetermined function value, according to one or more constraint conditions. The model of an integer programming problem is constructed based on the topology information 130, the path information 131, and the demand information 132.

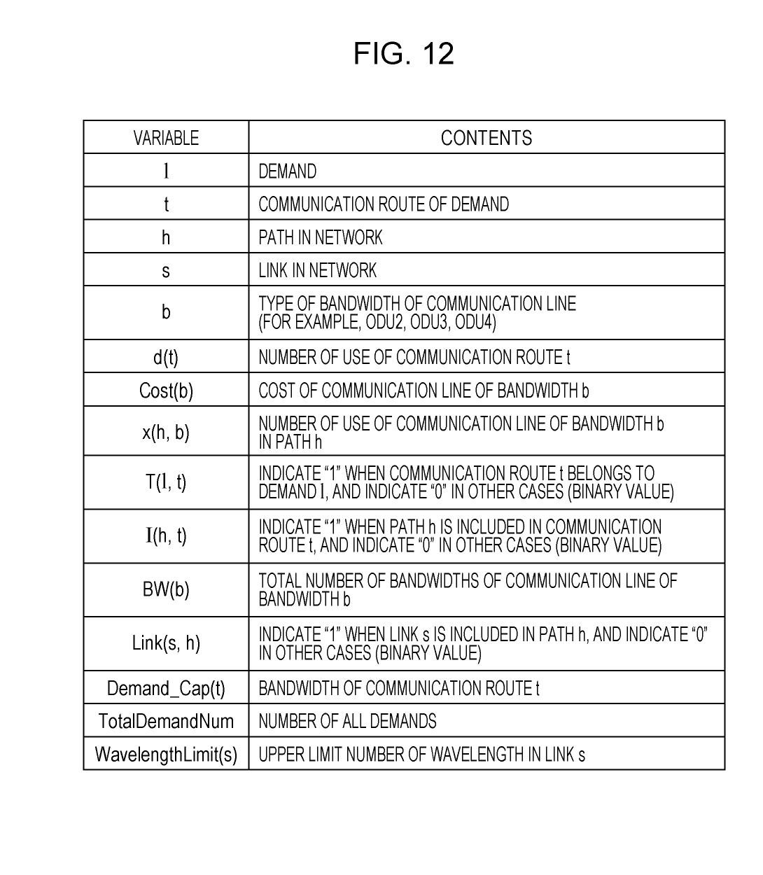

The first processing unit 100 uses, for example, the following Equation (1) as an objective function. FIG. 12 illustrates contents of variables used in a model of an integer programming problem constructed by the first processing unit.

$$Minimize \text{:} {\sum }_{h , b} Cost ( b ) \cdot x ( h , b ) \qquad ( 1 )$$

According to Equation (1), the first processing unit 100 estimates the bandwidth and the number of the communication lines such that the whole cost of the communication line in the network is minimized. The whole cost of the communication line is calculated as the sum of the products of the cost and the number of uses for respective types of the bandwidth. As described above, the cost of the communication line is determined based on the cost of the communication units 4a and 4b in which the optical transceivers 70a and 70b are respectively mounted.

The first processing unit 100 uses, for example, the following Equations (2) to (4), as the constraint condition.

$$\begin{matrix}{\sum }_{t} T ( l , t ) \cdot d ( t ) = TotalDemandNum ( for ∀ l ) & ( 2 ) \\ {\sum }_{t} Demand\_Cap ( t ) \cdot I ( h , t ) \cdot d ( t ) - {\sum }_{b} BW ( b ) \cdot x ( h , b ) \leq 0 ( for ∀ h ) & ( 3 ) \\ {\sum }_{h} {\sum }_{b} Link ( s , h ) \cdot x ( x , b ) \leq WavelengthLimit ( s ) ( for ∀ s ) & ( 4 )\end{matrix}$$

Equation (2) illustrates a constraint condition in which the sum of the numbers of communication routes which are selected according to respective demands is regarded as the number of whole demands. Equation (3) illustrates a constraint condition in which the sum of the bandwidths of the communication routes including the path for each path is equal to or less than the sum of products of the bandwidth and the number of use for respective types of the bandwidth of the communication line. Equation (4) illustrates a constraint condition in which the sum of the numbers of use of the paths included in the link for each link in the network is equal to or less than the upper limit of the number of wavelengths in the link. In addition, the upper limit number of the wavelength is the maximum number of the optical signals that can be multiplexed by the WDM device 9.

In this manner, the first processing unit 100 determines the communication route according to each demand such that the cost of the communication line is minimized, by obtaining the solution satisfying Equation (1) according to the constraint conditions of Equations (2) to (4), and estimates the bandwidth and the number of the communication lines opened in each path. Thus, the time desired for the design process of the communication line can be effectively reduced. In the present embodiment, the integer programming method is presented as an analysis method, but without being limited thereto, other methods such as a heuristic method can be used.

If FIG. 7 is referred to again, after the design process of the communication line (step St1), the second processing unit 101 selects a node in the network (step St2), and performs the line accommodation design of the shelf 5 for the selected node (step St3). At this time, the second processing unit 101 performs an estimation of the communication units 4a to 4c that constitute the communication line and the shelf 5 for the selected node, based on the estimation result of the first processing unit 100.

The line accommodation design is performed by solving a bottle backing problem in that the communication units 4a to 4c having different number of use of slots are accommodated in the shelf 5 having a predetermined maximum number of slots (24 in the example of FIG. 4) such that the number of shelves is minimized. In this case, the second processing unit 101, for example, similarly to the first processing unit, estimates the number of the shelves and the number of the communication units 4a to 4c by obtaining the solution by generating the model of the integer programming problem including an object function for minimizing the number of shelves. If the estimation for the selected node is completed, the second processing unit 101 writes the estimation result as the mounting state information 135 to the HDD 13.

Next, the third processing unit 102 determines whether there is the possibility of reduction in the number of shelves due to the change in the communication line for the node selected in step St2, based on each estimation result of the first processing unit 100 and the second processing unit 101 (step St4). The determination process will be described later.

When there is a possibility of reduction in the number of shelves (YES in step St4), the third processing unit 102 writes the upper limit number (first upper limit number) of communication lines that can be reduced as reduction possibility determination information 137 to the HDD 13 (step St5). Next, the third processing unit 102 determines whether or not the process of steps St2 to St7 is completed for all nodes in the network (step St8), and if not completed (NO in step St8), the process of step St2 is performed again. In this case, in the process of step St2, an unselected node is selected. In addition, the selection order of the nodes is not limited.

In contrast, when there is no possibility of reduction in the number of shelves (NO in step St4), the third processing unit 102 determines whether there is a risk of an increase in the number of shelves by performing again communication line design and the line accommodation design of the shelf (step St6). When there is the risk of an increase in the number of shelves (YES in step St6), the third processing unit 102 writes the upper limit number (second upper limit number) of the communication line not to increase the number of shelves as the increase risk determination information 138 to the HDD 13 (step St7). Next, the process of step St8 described above is performed. Even when there is no risk of an increase in the number of shelves (NO in step St6), the process of step St8 is performed.

Next, the third processing unit 102 determines whether there is a node having a possibility of reduction in the number of shelves (step St9). At this time, the third processing unit 102 refers to the reduction possibility determination information 137. The reduction possibility determination information 137 includes the determination result of step St4 for each node, as described later.

When the node having a possibility of reduction in the number of shelves is not present (NO in step St9), the third processing unit 102 terminates the process. When the node having a possibility of reduction in the number of shelves is present (YES in step St9), the third processing unit 102 determines whether or not the determination result of step St4 and step St6 is different from the previous result (step St10). At this time, third processing unit 102 refers to the reduction possibility determination information 137 and the increase risk determination information 138.

When the determination result is the same as the previous result (NO in step St10), the third processing unit 102 terminates the process. This does not allow the design process to be repeated although the determination result is the same.

When the determination result is different from the previous result (YES in step St10), the third processing unit 102 generates a constraint equation regarding the upper limit number (first and second upper limit numbers) of a communication line with respect to the node having a possibility of reduction in the number of shelves and the node having the risk of an increase in the number of shelves (step St11). At this time, the third processing unit 102 acquires the upper limit number of the communication line by referring to the reduction possibility determination information 137 and the increase risk determination information 138 which are stored in the HDD 13. Further, the third processing unit 102 writes the generated constraint equation as the constraint information 136 to the HDD 13. In addition, the generated constraint equation will be described later.

Next, the first processing unit 100 acquires a constraint equation by referring to the constraint information 136, and adds the constraint equation in the integer programming model of the communication line design (Equations (1) to (4) described above) (step St12). Then, the first processing unit 100 performs again the estimation of the communication line according to the constraint condition generated by the third processing unit 102 (step St1). Further, the second processing unit 101 performs again the estimation of the communication units 4a and 4b and the shelf 5, based on the result of the estimation that is performed again by the first processing unit 100. Thus, the estimation result of the second processing unit 101 is fed back to the communication line design of the first processing unit. Thus, the number of the communication lines and the number of shelves are minimized and the cost of both is reduced.

In this manner, the first processing unit 100 and the second processing unit 101 repeat the estimation until the third processing unit 102 determines that there is no possibility of reduction in the number of shelves for all nodes in the network (NO in step St9). Accordingly, since the estimation result of the second processing unit 101 is sufficiently fed back, various types of design parameters are adjusted and an optimal design result is obtained. In the manner described above, the network design is performed.

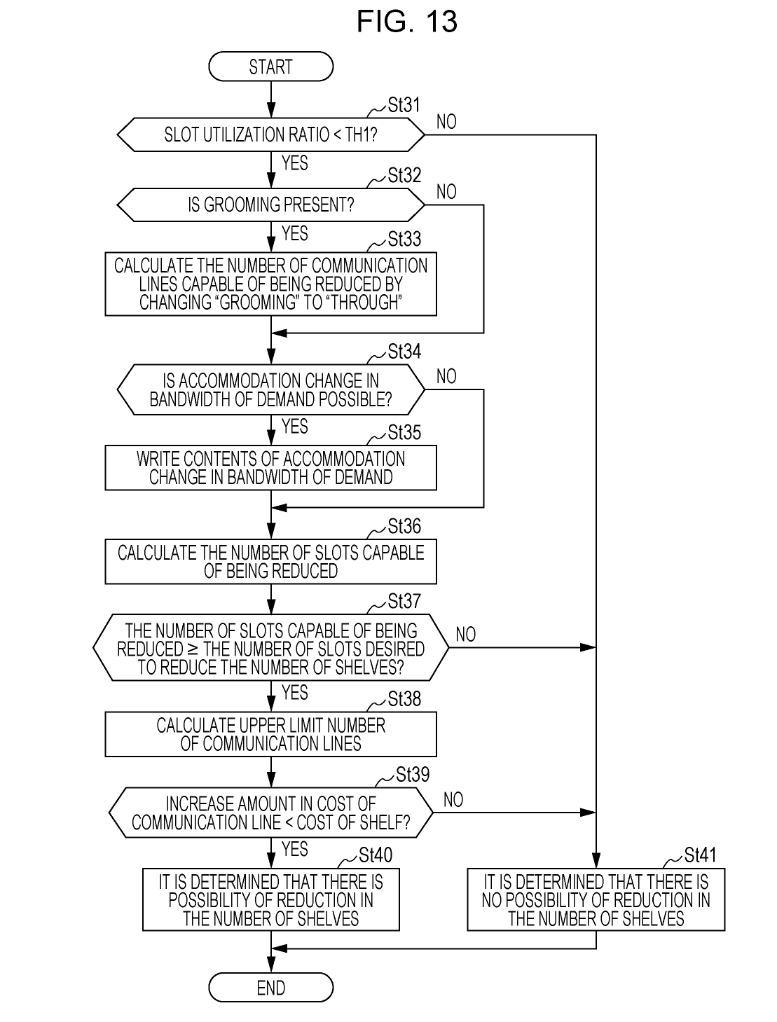

Next, the details of the determination process of step St4 described above will be described. FIG. 13 is a flow chart illustrating a determination process of a possibility of reduction in the number of shelves.

First, the third processing unit 102 determines whether the slot utilization ratio of the shelf 5 is less than a predetermined threshold TH1 (step St31). The slot utilization ratio is a ratio of the number of use of slots to the total number of slots of the shelf 5. When the WDM device 9 of the selected node includes a plurality of shelves 5 as the result of the line accommodation design of the shelf, the third processing unit 102 uses the lowest slot utilization ratio in the determination.

In the example FIG. 4, since it is assumed that the total number of slots is 24, when the communication units 4a to 4c use, for example, a total of 12 slots, the slot utilization ratio is 0.5 (=12/24). The threshold TH1 is a reference value used for roughly determining the possibility of reduction in the number of shelves, and is arbitrarily set by the user (for example, 0.2).

When the slot utilization ratio is equal to or greater than the predetermined threshold TH1 (NO in step St31), the third processing unit 102 determines that there is no possibility of reduction in the number of shelves (step St41). At this time, the third processing unit 102 writes the determination result as the reduction possibility determination information 137 to the HDD 13, and the third processing unit 102 terminates the process.

When the slot utilization ratio is less than the predetermined threshold TH1 (YES in step St31), the third processing unit 102 determines whether or not “grooming” is performed in the WDM device 9 of the selected node (step St32). At this time, the third processing unit 102 performs determination of whether there is the “grooming” by referring to the route information 133 and the line information 134 which are estimation result of the second processing unit 101.

When the “grooming” is performed (YES in step St32), the third processing unit 102 calculates the number of communication lines capable of being reduced by changing the “grooming” to the “through” (step St33). In the case of FIG. 10, if it is assumed that the communication route candidate 1 is selected, the path of the optical signal in the node C is switched from the path 1 to the path 2 so that the “grooming” is performed. However, when the communication route is changed to the candidate 5, the switching of the path in the node C does not occur, and thus the “through” is performed.

In this manner, if the change from the “grooming” to the “through” occurs, the signal route in the WDM device 9 is changed from the route R1 to route R2, illustrated in FIG. 3, so that the desired number of the optical transceiver 70 is reduced by two. In other words, it is possible to reduce the communication line by one. The third processing unit 102 writes the total number of the communication lines capable of being reduced as the reduction possibility determination information 137 to the HDD 13.

Further, when the “grooming” is not performed (NO in step St32), the third processing unit 102 does not perform the process of step St33.

Next, the third processing unit 102 determines whether or not the accommodation change in the bandwidth of the demand is possible (step St34). The accommodation change in the bandwidth of the demand refers to changing the accommodation destination of the bandwidth BW4 of the demand 4 from the communication line 2 to the communication line 1, in the example of FIG. 11.

In other words, the accommodation change in the bandwidth of the demand is replacing the communication line of a plurality of narrow bandwidths (in the present embodiment, ODU2) with the communication line of one wide bandwidth (in the present embodiment, ODU4). The example will be described later.

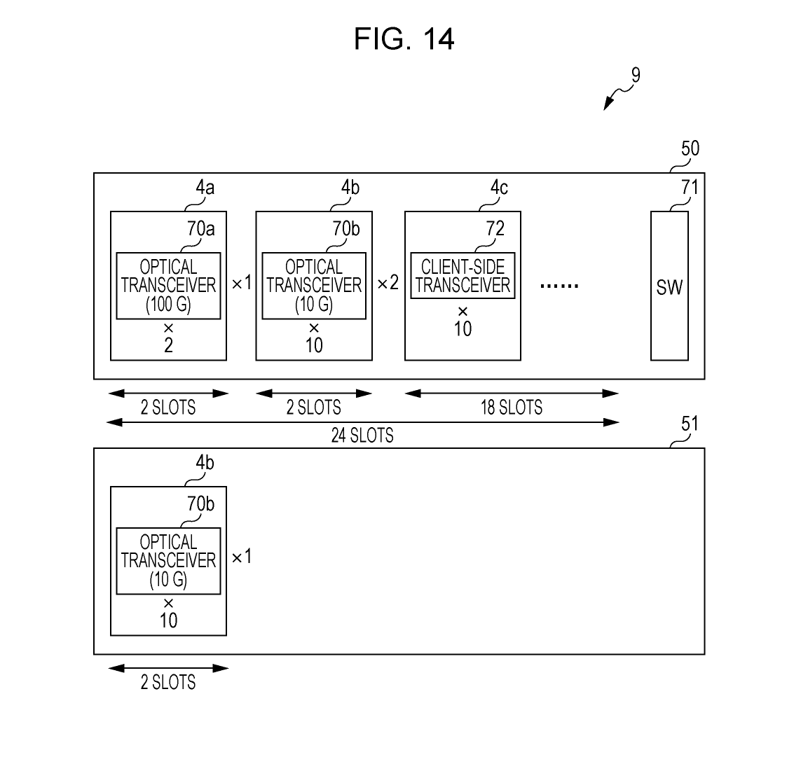

FIG. 14 is a configuration diagram illustrating an example of a mounting state of a WDM device 9. The WDM device 9 includes a first shelf 50 and a second shelf 51. The first shelf 50 accommodates a switch 71, one first communication unit 4a, two second communication units 4b, and a third communication unit 4c of 18 slots. Since the first and second communication units 4a and 4b both have the number of use of slots as two, the first shelf 50 uses all slots.

In contrast, the second shelf 51 accommodates one second communication unit 4b. Since the slot utilization ratio of the second shelf 51 is 0.08 (≅2/24), if it is assumed that the threshold TH1=0.2, it is established that the slot utilization ratio <TH1 (see step St31).

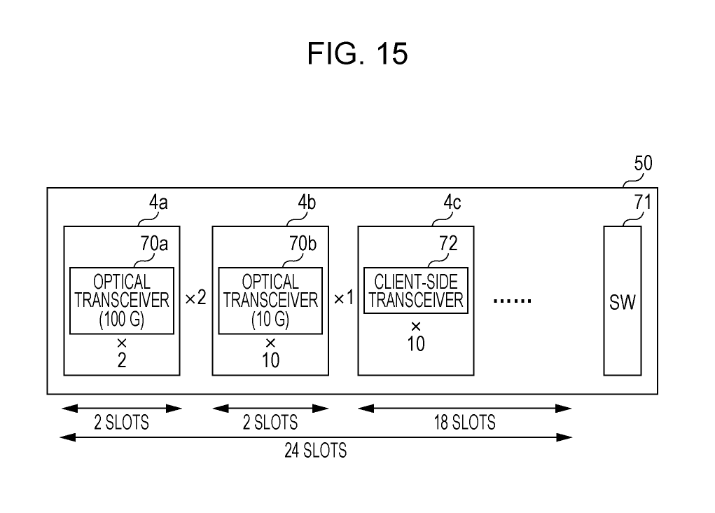

FIG. 15 is a configuration diagram illustrating an example of a mounting state of the WDM device 9 when a communication line is changed. In the mounting state of FIG. 14, the present embodiment illustrates the mounting state when two second communication units 4b are replaced with one first communication unit 4a. The sum of the bandwidths of the communication lines of two second communication units 4b is 200 (Gbps) (=2 (pieces)×10 (Gbps)×10 (pieces)), and it is equal to the bandwidth (100 (Gbps)×2 (pieces)) of one first communication unit 4a. Therefore, two second communication units 4b can be replaced with one first communication unit 4a.

In the present mounting state, since the number of use of slots is 24, the second shelf 51 is not used. In other words, the number of shelves is reduced to one from two by the replacement described above. The third processing unit 102 writes the contents of the accommodation change in the bandwidth of the demand as the reduction possibility determination information 137 to the HDD 13. As steps St32, St34, the determination of the possibility of reduction in the number of shelves is easily performed by considering the change in the bandwidth of the communication line.

If FIG. 13 is referred to again, when the accommodation change in the bandwidth of the demand is possible (YES in step St34), the third processing unit 102 writes the contents of the accommodation change in the bandwidth of the demand as the reduction possibility determination information 137 to the HDD 13 (step St35). Further, when the accommodation change in the bandwidth of the demand is not possible (NO in step St34), the third processing unit 102 does not perform the process of step St35.

Next, the third processing unit 102 calculates the number of slots capable of being reduced, based on the determination result (step St32 to St35) regarding the change in the communication line (step St36). At this time, the third processing unit 102 acquires the total number of the communication lines capable of being reduced (see step St33) and the content of the accommodation change in the bandwidth of the demand (see step St35) by referring to the reduction possibility determination information 137, and calculates the number of slots capable of being reduced.

Next, the third processing unit 102 determines whether or not the number of slots capable of being reduced is greater than or equal to the number of slots desired in order to reduce the number of shelves (step St37). The number of shelves desired to reduce the number of slots is the minimum number of use among the number of use of slots of, for example, a plurality of shelves 5, and in the case of the example of FIG. 14, it is two.

When the number of slots capable of being reduced is less than the number of slots desired to reduce the number of shelves, the third processing unit 102 determines that there is no possibility of reduction in the number of shelves (step St41). At this time, the third processing unit 102 writes the determination result as the reduction possibility determination information 137 to the HDD 13. Then, the third processing unit 102 terminates the process.

Further, when the number of slots capable of being reduced is equal to or greater than the number of slots desired to reduce the number of shelves (YES in step St37), the third processing unit 102 calculates the upper limit number (first upper limit number) of communication lines that allow reduction in the number of shelves (step St38). The upper limit number of the communication line is the upper limit of the number of the communication lines as the target to reduce the number of shelves for each type of bandwidth in the selected node.

In the case of the example of FIG. 14, if there is no second communication unit 4b accommodated in the second shelf 51, the number of shelves is reduced by one, and thus the upper limit number of the communication line is the number of the communication lines accommodated in the first shelf 50. In other words, the upper limit number of the communication line is 20 (pieces) for ODU2 (10 (Gbps)), and is 2 (pieces) for ODU4 (100 (Gbps)).

Further, as described with reference to FIG. 15, when a plurality of the communication lines of ODU2 are arranged into the communication line of ODU4, the upper limit number of the communication line is the number of communication lines accommodated in the first shelf 50 illustrated in FIG. 15. In other words, the upper limit number of the communication line is 10 (pieces) for ODU2 (10 (Gbps)), and is four (pieces) for ODU4 (100 (Gbps)). In addition, in each of the examples, since the number of the third communication unit 4c depends on the demand, it is treated as a fixed number, and may not be considered for the reduction.

Next, the third processing unit 102 determines whether or not the increased amount in the cost of the communication line which is estimated by the process of steps St32 to St38 is less than the cost of the shelf 5 (step St39). In the case of the example of FIG. 14, if it is assumed that the cost of the first communication unit 4a is higher than the cost of the second communication unit 4b, as illustrated in the example of FIG. 15, an increase in cost can be expected by replacing the second communication unit 4b with the first communication unit 4a. When the increased amount in the cost exceeds the cost of the shelf 5, even if it is possible to reduce the number of shelves, there is no benefit gained from cost reduction.

When the increase amount in the cost of the communication line is equal to or greater than the cost of the shelf 5 (NO in step St39), the third processing unit 102 determines that there is no possibility of reduction in the number of shelves (step St41). At this time, the third processing unit 102 writes the determination result as the reduction possibility determination information 137 to the HDD 13. Thus, the third processing unit 102 terminates the process.

In this manner, when the increase amount of the cost due to the change in the bandwidth of the communication line exceeds the decreased amount of the cost due to the reduction in the number of shelves, the third processing unit 102 determines that there is no possibility of reduction in the number of shelves. Accordingly, the increase of the cost due to the reduction in the number of shelves does not occur.

Furthermore, when the increase amount of the cost of the communication line is less than the cost of the shelf 5 (YES in step St39), the third processing unit 102 determines that there is the possibility of reduction in the number of shelves (step St40). The third processing unit 102 writes the determination result as the reduction possibility determination information 137 to the HDD 13. In this case, an advantage of cost reduction due to the reduction in the number of shelves is achieved. In this manner, the determination process of the reduction possibility of the number of shelves is performed.

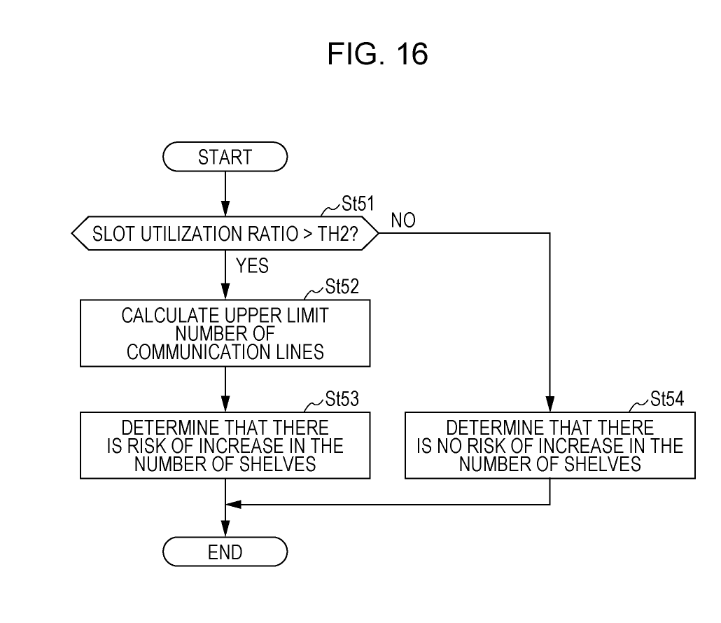

Next, the details of the determination process of step St6 in FIG. 7 will be described. FIG. 16 is a flow chart illustrating a determination process of increase risk of the number of shelves.

The third processing unit 102 determines whether or not the slot utilization ratio of the shelf 5 is greater than a predetermined threshold TH2 (step St51). The slot utilization ratio, as described above, is a ratio of the number of use of slots to the total number of slots of the shelf 5. The threshold TH2 is a reference value for roughly determining the risk of an increase in the number of shelves, and is arbitrarily set by the user (for example, 0.9).

When the slot utilization ratio of the shelf 5 is equal to or less than the predetermined threshold TH2 (NO in step St51), the third processing unit 102 determines that there is no risk of an increase in the number of shelves (step St54). At this time, the third processing unit 102 writes the determination result as the increase risk determination information 138 to the HDD 13.

When the slot utilization ratio of the shelf 5 is greater than the predetermined threshold TH2 (YES in step St51), the third processing unit 102 calculates the upper limit number (second upper limit number) of the communication line not to increase the number of shelves (step St52). The upper limit number of the communication line is obtained from the number of the communication units 4a and 4b which are accommodated in the shelf 5, and from the number of unoccupied slots of the shelf 5, based on the estimation result of the second processing unit 101.

For example, it is assumed that for one shelf 5, the total number of the optical transceivers 70a of the first communication unit 4a is X, the total number of the optical transceivers 70b of the second communication unit 4b is Y, and the number of unoccupied slots is two. At this time, since one second communication unit 4b can be accommodated in two unoccupied slots, ten optical transceivers 70b can be mounted in one second communication unit 4b, and the upper limit number of the communication line of ODU2 (10 (Gbps)) is Y+10. Since the total number of the optical transceiver 70a of the first communication unit 4a is maintained, the upper limit number of the communication line of ODU4 (100 (Gbps)) is X.

The example is an example of the upper limit number when the increase in the communication line of the first communication unit 4a, that is, ODU4, is not allowed. When the increase in the communication line of ODU4 is allowed, one first communication unit 4a can be accommodated in two unoccupied slots. Since two optical transceivers 70a are mounted in one second communication unit 4b, the upper limit number of the communication line of ODU4 (100 (Gbps)) is X+2. Since the total number of the optical transceiver 70b of the second communication unit 4b is maintained, the upper limit number of the communication line of ODU2 (10 (Gbps)) is Y.

Next, the third processing unit 102 determines whether or not there is the risk of an increase in the number of shelves for the node (step St53). At this time, the third processing unit 102 writes the determination result as the increase risk determination information 138 to the HDD 13. In this manner, the determination process of the risk of an increase in the number of shelves is performed.

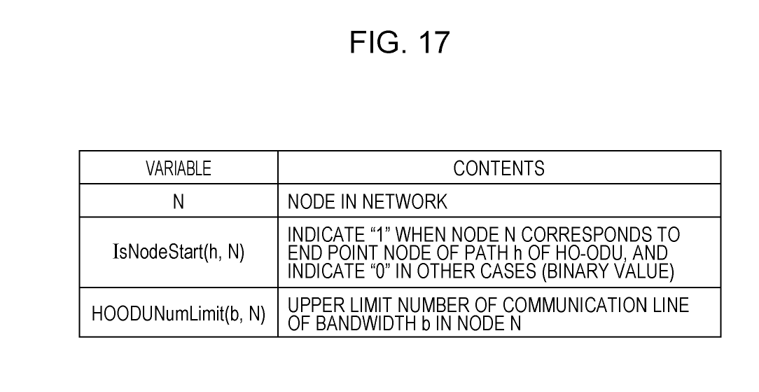

Next, the constraint equation generated in step St11 of FIG. 7 will be described. The third processing unit 102 generates the following constraint Equation (5) as the constraint condition based on the upper limit number (first and second upper limit numbers) of the communication line, for the node having a possibility of reduction in the number of shelves and the node having the risk of an increase in the number of shelves. FIG. 17 illustrates contents of variables used in a constraint equation generated by a third processing unit.

$${\sum }_{h} IsNodeStart ( h , N ) \cdot x ( h , b ) \leq HOODUNumLimit ( b , N ) ( for ∀ N , ∀ b ) \qquad ( 5 )$$

Equation (5) illustrates a constraint condition in which the number of use of communication line for each type of the bandwidth is equal to or less than the upper limit number of the communication line when each of the nodes corresponds to the end point node of a path. As the upper limit number of the communication line, in a case of the node having a possibility of reduction in the number of shelves, the value calculated in the process of step St38 of FIG. 13 is used; in contrast, in a case of the node having the risk of an increase in the number of shelves, the value calculated in the process of step St52 of FIG. 16 is used.

Further, if the example of FIG. 11 is exemplified with respect to the end point node of a path, the nodes A, D, and F correspond to the end point nodes of the paths 9 and 3. As described above, since at least one of the “insertion” and “branching” of the optical signal is performed in the end point node of the path, the optical transceivers 70a and 70b constituting the communication line are used. According to the constraint condition of Equation (5), the number of the optical transceivers 70a and 70b is limited for each type of the bandwidth (ODU2 and ODU4). Accordingly, the number of the communication units 4a and 4b accommodated in the shelf 5 is limited by adding Equation (5) to the model of an integer programming problem in the process of step St24 of FIG. 8 (see step St12 of FIG. 7).

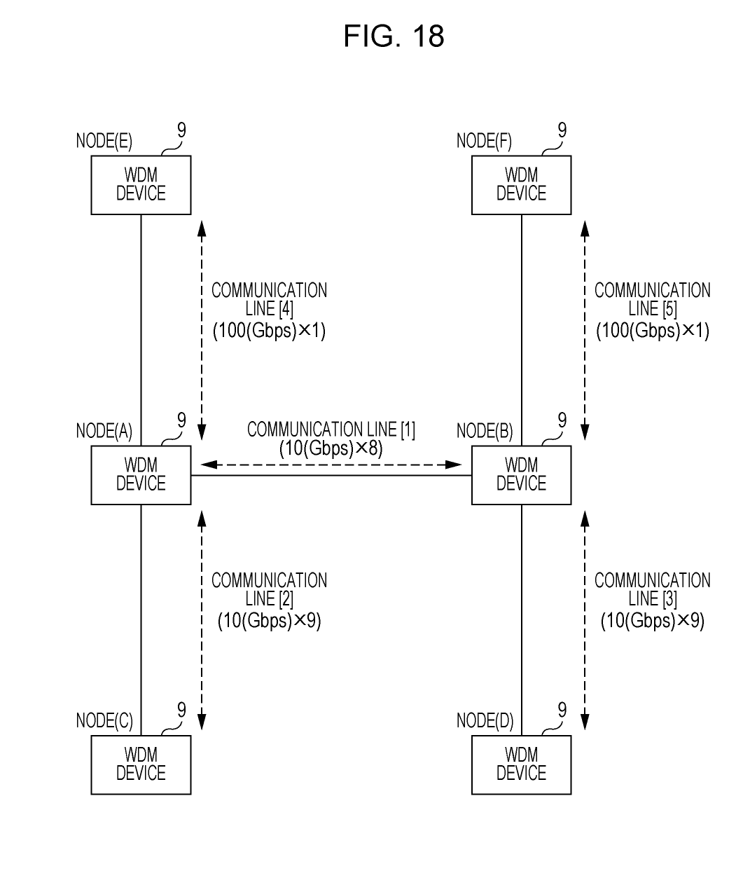

Next, the effect of the embodiment will be described by comparison with the comparative example. FIG. 18 illustrates a result of a communication line design of the first comparative example.

In the first comparative example, design is completed by the line accommodation design of the shelf 5 being performed by the second processing unit 101 after the communication line design being performed by the first processing unit 100, while the result of the line accommodation design is not fed back to the communication line design. Further, the line accommodation design of the shelf 5 of each node is not performed as the entirety of the network, but is individually performed.

In the network to be designed, the node (A) to node (F) are connected to form an H shape. It is assumed that the nodes (A) and (B) have the possibility of reduction in the number of shelves, and other nodes (C) to (F) do not have the possibility of reduction in the number of shelves.

The communication line [1] is opened between the node (A) and the node (B), and the communication line [2] is opened between the node (A) and the node (C), and the communication line [4] is opened between the node (A) and the node (E). Further, the communication line [3] is opened between the node (B) and the node (D), and communication line [5] is opened between the node (B) and the node (F).

As the result of the communication line design, the number of the communication line [1] is 10 (Gbps) (ODU2)×8 (pieces) and the number of the communication line [2] is 10 (Gbps) (ODU2)×9 (pieces). The number of the communication line [3] is 10 (Gbps) (ODU2)×9 (pieces) and the number of the communication lines [4] and [5] is 100 (Gbps) (ODU4)×1 (pieces).

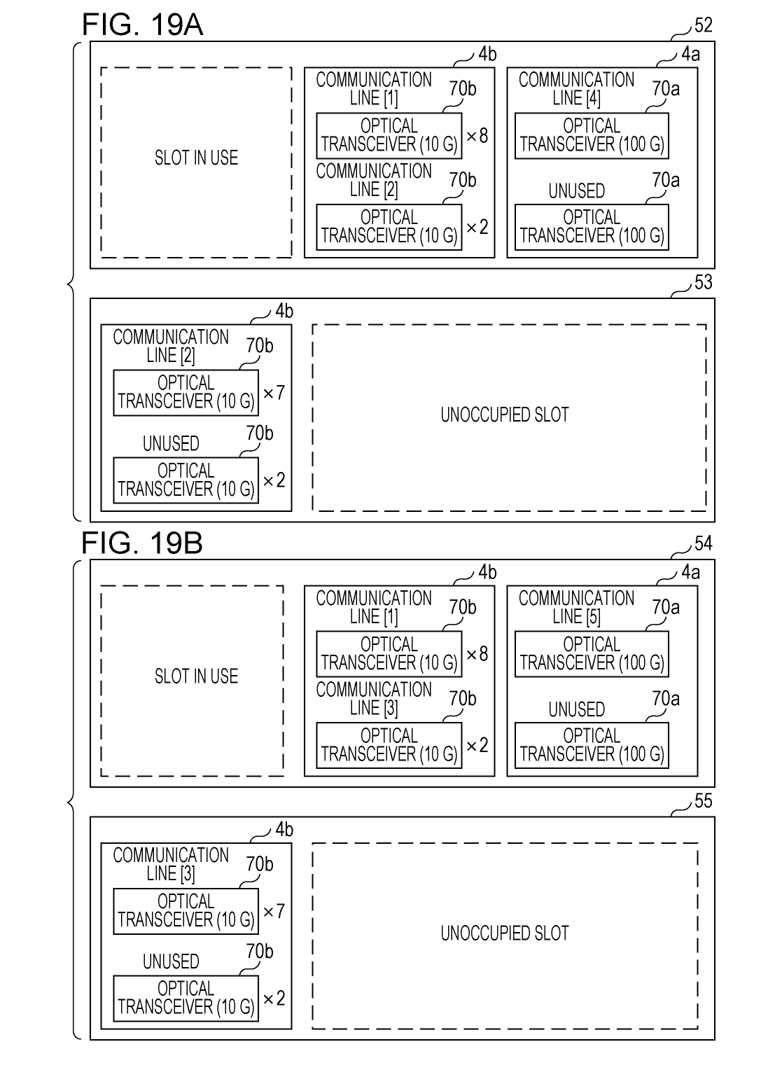

Further, FIGS. 19A and 19B illustrate a result of a line accommodation design of the shelf 5 of the first comparative example. More specifically, FIG. 19A illustrates the result of the line accommodation design of the shelf 5 of the node (A), and FIG. 19B illustrates the result of the line accommodation design of the shelf 5 of the node (B).

Further, FIGS. 19A and 19B illustrate the communication lines [1] to [5] configured with the optical transceivers 70a and 70b and the numbers thereof for respective optical transceivers 70a and 70b which are mounted in the communication units 4a and 4b. In addition, the optical transceivers 70a and 70b, which are denoted by “unused”, indicate that they do not constitute any one of the communication lines [1] to [5].

According to the present comparative example, as the result of the line accommodation design of the shelf 5, it is estimated that two shelves among shelves 52 to 55 are respectively used for the nodes (A) and (B). The shelf 52 on one side of the node (A) accommodates the second communication unit 4b used in the communication lines [1] and [2] and the first communication unit 4a used in the communication lines [4], and all slots are used. The shelf 53 on the other side of the node (A) accommodates only the second communication unit 4b used in the communication line [2], and other slots are unoccupied.

Further, the shelf 54 on one side of the node (B) accommodates the second communication unit 4b used in the communication lines [1] and [3] and the first communication unit 4a used in the communication lines [5], and all slots are used. The shelf 55 on the other side of the node (B) accommodates only the second communication unit 4b used in the communication line [3], and all slots are used.

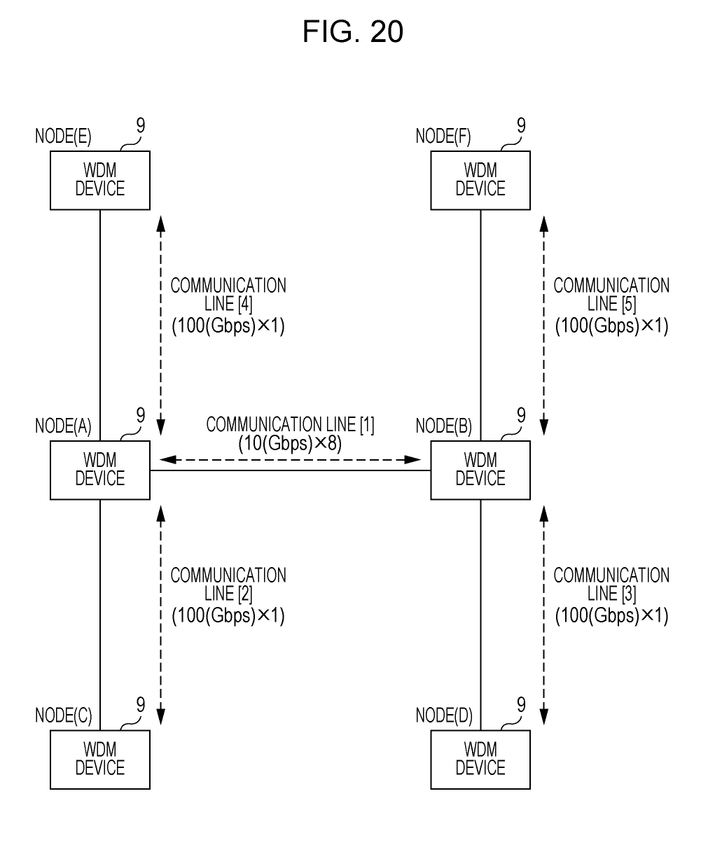

FIG. 20 illustrates a result of a communication line design of a second comparative example. Here, the form of the network to be designed is the same as that of the first comparative example. In the second comparative example, in addition to the contents of the first comparative example, the accommodation change in the bandwidth of the demand (see step St34 of FIG. 13) is individually performed for respective nodes.

As the result of the communication line design, the number of the communication line [1] is 10 (Gbps) (ODU2)×8 (pieces) and the number of the communication lines [2] to [5] are respectively 100 (Gbps) (ODU4)×1 (pieces).

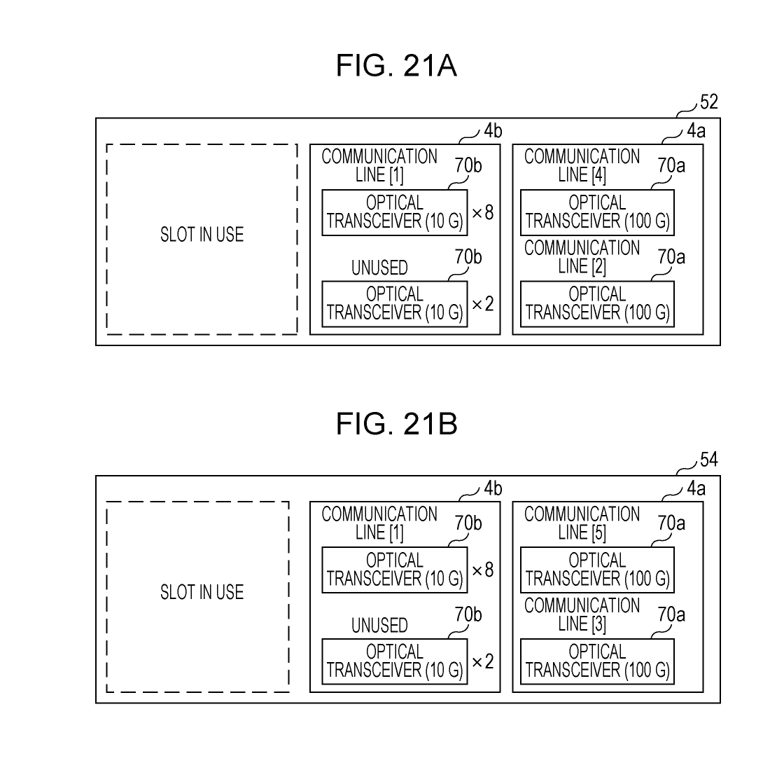

Further, FIGS. 21A and 21B illustrate a result of a line accommodation design of the shelf 5 of the second comparative example. More specifically, FIG. 21A illustrates the result of the line accommodation design of the shelf 5 of the node (A), and FIG. 21B illustrates the result of the line accommodation design of the shelf 5 of the node (B).

According to the present comparative example, as the result of the line accommodation design of the shelf 5, it is estimated that the shelves 52 and 54 are respectively used for the nodes (A) and (B). The shelf 52 of the node (A) accommodates the second communication unit 4b used in the communication line [1], and the first communication unit 4a used in the communication lines [2] and [4], and all slots are used. The shelf 54 of the node (B) accommodates the second communication unit 4b used in the communication line [1], and the first communication unit 4a used in the communication lines [3] and [5], and all slots are used.

In this manner, according to the present comparative example, when it is compared with the first comparative example, the bandwidth of the communication lines [2] and [3] is changed from ODU2 to ODU4, and thus the shelf 5 of the nodes (A) and (B) is reduced by one. However, if it is assumed that the bandwidth of the communication lines [2] and [3] is ODU4, the first communication unit 4a corresponding to ODU4 is used also for the nodes (C) and (D) as well as the nodes (A) and (B). In other words, as the entire network, the communication line of ODU4 is increased by two. Therefore, if it is assumed that the cost of the communication line of ODU4 is greater than the cost of the shelf 5, the cost of the entire network is increased.

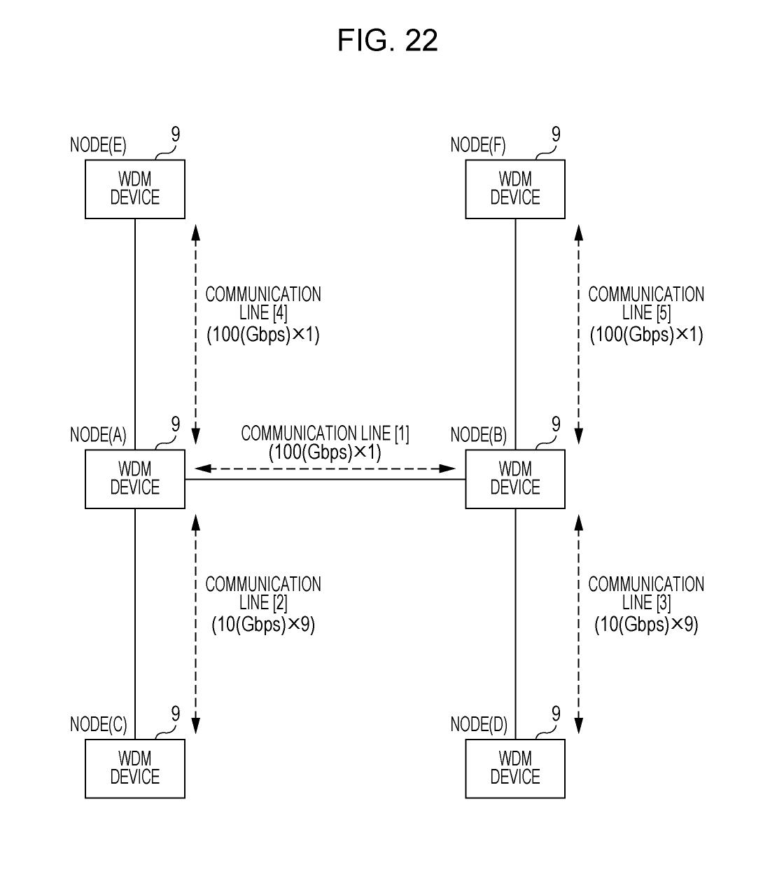

FIG. 22 illustrates a result of a communication line design of an embodiment. Here, the form of the network to be designed is the same as those in the cases of the first comparative example and the second comparative example.

As the result of the communication line design, the number of the communication line [1] is 100 (Gbps) (ODU4)×1 (pieces), and the number of the communication line [2] is 10 (Gbps) (ODU2)×9 (pieces). The number of the communication line [3] is 10 (Gbps) (ODU2)×9 (pieces), and the number of the communication lines [4] and [5] is 100 (Gbps) (ODU4)×1 (pieces).

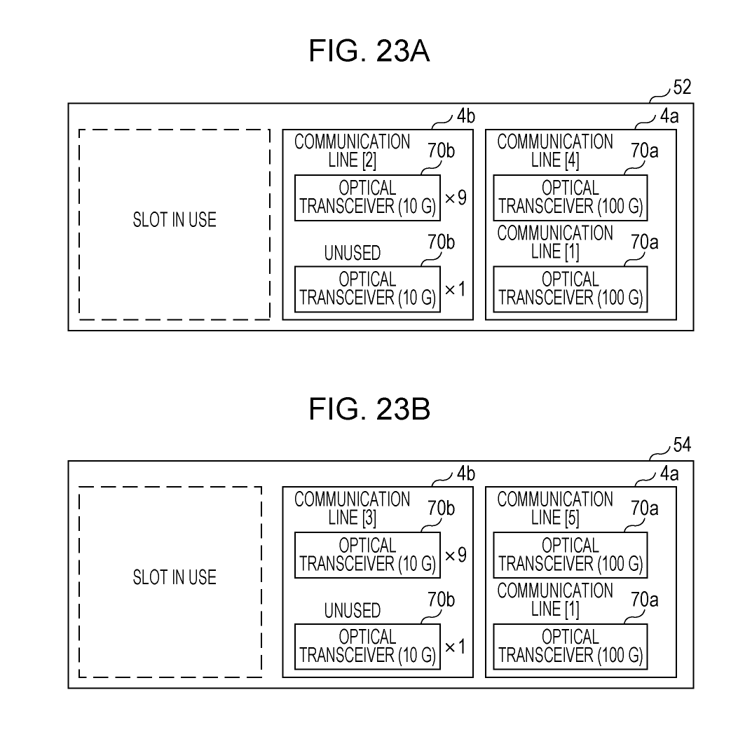

Further, FIGS. 23A and 23B illustrate the result of the line accommodation design of the shelf 5 of the embodiment. More specifically, FIG. 23A illustrates the result of the line accommodation design of the shelf 5 of the node (A), and FIG. 23B illustrates the result of the line accommodation design of the shelf 5 of the node (B).

According to the embodiment, as the result of the line accommodation design of the shelf 5, it is estimated that one of shelves 52 and 54 is respectively used for the nodes (A) and (B). The shelf 52 of the node (A) accommodates the second communication unit 4b used in the communication line [2], and the first communication unit 4a used in the communication lines [1] and [4], and all slots are used. The shelf 54 of the node (B) accommodates the second communication unit 4b used in the communication line [3], and the first communication unit 4a used in the communication lines [1] and [5], and all slots are used.

In this manner, according to the embodiment, since the design process in the entire network is performed, only the bandwidth of the communication line [1] is changed from ODU2 to ODU4, and the shelves 5 of the nodes (A) and (B) is reduced by one. Accordingly, as the entire network, the increased number of the communication line of ODU4 remains one. Therefore, even if the cost of the communication line of ODU4 is greater than the cost of the shelf 5, the cost of the entire network is minimized.

If the first comparative example and the embodiment are compared, as the design result of the network, the number of shelves of nodes (A) and (B) in the embodiment is ½ of that of the case of the first comparative example. Therefore, according to the embodiment, as an example, the cost of the entire network is reduced to ½ or so.

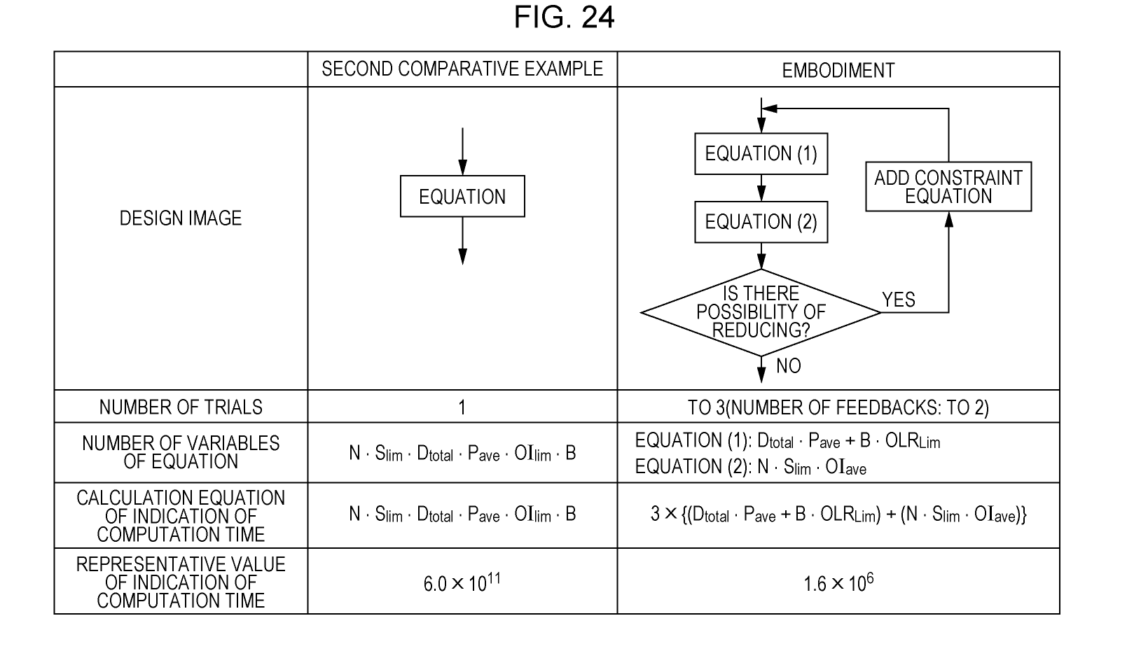

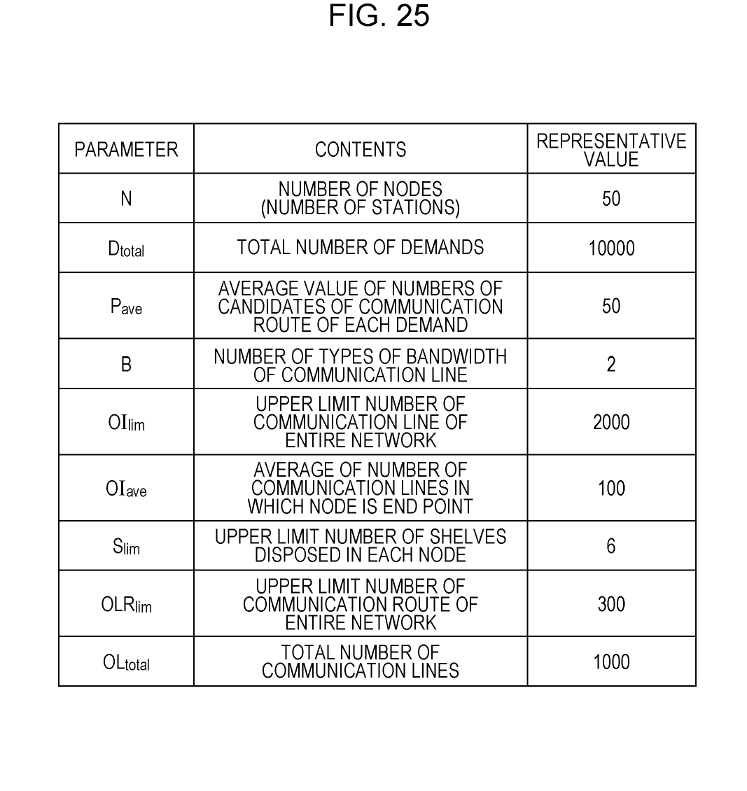

Further, if the second comparative example described above and the embodiment are compared, the time desired for the network design in the embodiment is reduced to 1/10⁵ or less of that of the case of the second comparative example. FIG. 24 is a table comparing the second comparative example and the embodiment. FIG. 25 illustrates contents of variables used in FIG. 24.

In FIG. 24, “design image” represents the flow of the network design process. In the second comparative example, the design is completed by solving the equation once. In contrast, in the embodiment, after Equation (1) corresponding to the communication line design is solved (see step St1 of FIG. 7), Equation (2) corresponding to the line accommodation design of the shelf 5 is solved (see step St3 of FIG. 7). Then, whether there is the possibility of reduction in the number of shelves is determined (see step St4 of FIG. 7), when there is the possibility, after the constraint equation is added (see step St12 of FIG. 7), again, after Equation (1) is solved, Equation (2) is solved. The process is repeated until it is determined that there is no possibility of reduction in the number of shelves.

Further, “number of trials” is the number of times of the repeat process performed in the network design process. Since the repeat process is not performed in the second comparative example, the “number of trials” is one. In contrast, the “number of trials” of the embodiment is about three at maximum. At this time, the number of times of a feedback process which adds the constraint equation is about two at maximum.

The “number of variables in the equation” represents the number of variables used in the equation described in the “design image” by the equation of a parameter. In the case of the embodiment, the variables of two Equations (1) and (2) are respectively illustrated. In addition, the contents of respective parameters used in the “number of variables in the equation” are described in FIG. 25.

The “calculation equation of indication of computation time” represents the entire time desired for the network design process by the equation of parameters of FIG. 25. The “representative value of indication of computation time” is a value obtained by substituting each parameter of the equation described in the “calculation equation of indication of computation time” with each representative value described in FIG. 25.

The “representative value of indication of computation time” of the second comparative example is 6.0×10¹¹; in contrast, the “representative value of indication of computation time” of the embodiment is 1.6×10⁶. Therefore, according to the embodiment, the time desired for network design is reduced to 1/10⁵ or less of that in the case of the second comparative example.

As described hitherto, the network design apparatus 1 according to the embodiment includes a first processing unit 100, a second processing unit 101, and a third processing unit 102. The first processing unit 100 determines a communication route connecting predetermined nodes by selecting one or more paths which are provided between nodes in the network, in response to traffic demand between predetermined nodes in the network. Then, the first processing unit 100 performs the estimation of the communication lines opened in each of the one or more paths which are selected.

The second processing unit 101 performs the estimation of the communication apparatuses (communication units) 4a and 4b constituting the communication line, and the housing (shelf) 5 which accommodates the communication apparatuses 4a and 4b, for each node in the network, based on the estimation result of the first processing unit 100. The third processing unit 102 determines whether there is the possibility of reduction in the number of housings 5 (number of shelves) due to the change in the communication line, for each node in the network, based on respective estimation results of the first processing unit 100 and the second processing unit 101.

When it is determined that there is the possibility of reduction in the number of housings 5, the third processing unit 102 generates the constraint condition based on the first upper limit number of the communication line that can be reduced for each node. The first processing unit 100 performs again the estimation of the communication line according to the constraint condition based on the first upper limit number. The second processing unit 101 performs again the estimation of the communication apparatuses 4a and 4b and the housing 5, based on the estimation result.

According to the network design apparatus 1 according to the embodiment, a communication line design is performed in order for the first processing unit 100 to perform an estimation of communication lines opened in respective paths constituting the communication route according to the demanded traffic. The second processing unit 101 performs an estimation of the communication apparatuses 4a and 4b constituting the communication line and the housing 5 based on the estimation result of the first processing unit 100 so as to perform the accommodation design of the housing (shelf) 5.

The third processing unit 102 generates a constraint condition based on the first upper limit number of the communication line that can be reduced for the node having the possibility of reduction in the number of housings 5 as determined based on respective estimation result of the first processing unit 100 and the second processing unit 101. The first processing unit 100 performs again the estimation of the communication line according to the constraint condition based on the first upper limit number, and the second processing unit 101 performs again the estimation of the communication apparatuses 4a and 4b and the housing 5, based on the result of the estimation that is performed again by the first processing unit 100.

Accordingly, the result of the accommodation design of the housing 5 is fed back to the design process of the communication line, and the estimation of the communication line is performed so as to reduce the number of housings 5. For this reason, according to the network design apparatus 1, it is possible to efficiently design a network of low cost in consideration of both the number of housings 5 and the number of the communication lines.

Further, the network design method according to the embodiment includes first to third steps. In the first step, a communication route connecting predetermined nodes is determined by selecting one or more paths provided between nodes in the network in response to traffic demand between predetermined nodes in the network. In the first step, the estimation of the communication lines opened in each of the one or more selected paths is performed.

In the second step, the estimation of the communication apparatuses (communication units) 4a and 4b constituting the communication line, and the housing (shelf) 5 which accommodates the communication apparatuses 4a and 4b is performed for each node in the network, based on the estimation result of the communication line. In the third step, whether there is the possibility of reduction in the number of housings 5 due to the change in the communication line is determined for each node in the network, based on respective estimation results of the communication line, the communication apparatuses 4a and 4b, and the housing 5.

In the third step of determining whether there is the possibility of reduction in the number of housings 5, when it is determined that there is the possibility of reduction in the number of housings 5, a constraint condition is generated based on the first upper limit number of the communication line which can be reduced, for each node. The first step of estimating the communication line is performed again according to the constraint condition based on the first upper limit number. The second step of estimating the communication apparatuses 4a and 4b and the housing 5 is performed again, based on the estimation result of the communication line which is performed again.

Accordingly, since the network design method according to the embodiment has the same configuration as that of the network design apparatus 1, the same effect as the contents described above is achieved.

Further, the network design program according to the embodiment includes first to third processes executed in a computer. In the first process, a communication route connecting predetermined nodes is determined by selecting one or more paths provided between nodes in the network in response to traffic demand between predetermined nodes in the network. In the first process, the estimation of the communication lines opened in each of the one or more selected paths is performed.

In the second process, the estimation of the communication apparatuses (communication units) 4a and 4b constituting the communication line, and the housing (shelf) 5 which accommodates the communication apparatuses 4a and 4b is performed for each node in the network, based on the estimation result of the communication line. In the third process, whether there is the possibility of reduction in the number of housings 5 due to the change in the communication line is determined for each node in the network, based on respective estimation results of the communication line, the communication apparatuses 4a and 4b, and the housing 5.

In the third process of determining whether there is the possibility of reduction in the number of housings 5, when it is determined that there is the possibility of reduction in the number of housings 5, a constraint condition is generated based on the first upper limit number of the communication line which can be reduced, for each node. The first process of estimating the communication line is performed again according to the constraint condition based on the first upper limit number. The second process of estimating the communication apparatuses 4a and 4b and the housing 5 is performed again, based on the estimation result of the communication line which is performed again.

Accordingly, since the network design program according to the embodiment has the same configuration as that of the network design apparatus 1, the same effect as the contents described above is achieved.

Although the foregoing has described in detail the contents of the embodiments with reference to the preferred embodiments, it is obvious that those skilled in the art could easily adopt various modifications based on the basic technology concept and teachings of the embodiments.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A network design apparatus comprising:
a first processing unit configured to determine a communication route that connects predetermined nodes by selecting one or more paths provided between the nodes in a network, in response to traffic demand between the predetermined nodes in the network, and to perform an estimation of communication lines opened in each of the selected one or more paths;
a second processing unit configured to perform an estimation of communication apparatuses constituting the communication line and a housing that accommodates the communication apparatuses, for each node in the network, based on an estimation result of the first processing unit; and
a third processing unit configured to determine whether there is a possibility of reduction in the number of the housings due to a change in the communication line, for each node in the network, based on respective estimation results of the first processing unit and the second processing unit,
wherein the third processing unit generates a constraint condition that causes the reduction in the number of the housings, based on a first upper limit number of the communication line, for each node, when the third processing unit determined that there is the possibility of reduction in the number of the housings,
wherein the first processing unit performs again the estimation of the communication line according to the constraint condition based on the first upper limit number, and
wherein the second processing unit performs again the estimation of the communication apparatuses and the housing, based on the result of the estimation that is performed again by the first processing unit.

2. The network design apparatus according to claim 1,
wherein the first processing unit and the second processing unit repeat the estimation until the third processing unit determines that there is no possibility of reduction in the number of the housings, for all nodes in the network.

3. The network design apparatus according to claim 1,
wherein the third processing unit determines a possibility of reduction in the number of the housings due to a change in a bandwidth of the communication line.

4. The network design apparatus according to claim 3,
wherein the third processing unit determines that there is no possibility of reduction in the number of the housings, when an increase amount of cost due to the change in the bandwidth of the communication line exceeds a decrease amount of cost due to a reduction in the number of the housings.

5. The network design apparatus according to claim 1,
wherein when determined that there is no possibility of reduction in the number of the housings, the third processing unit determines whether there is a risk of increase in the number of the housings due to re-execution of respective estimations of the first processing unit and the second processing unit, for the node, and when determined that there is the risk of increase in the number of the housings, the third processing unit generates a constraint condition based on a second upper limit number of the communication line of not increasing the number of the housings,
wherein the first processing unit performs again the estimation of the communication line according to the constraint condition based on the second upper limit number, and
wherein the second processing unit performs again the estimation of the communication apparatuses and the housing, based on a result of the estimation that is performed again by the first processing unit.

6. A network design method causing a computer to execute:
determining a communication route that connects predetermined nodes by selecting one or more paths provided between the nodes in a network, in response to traffic demand between the predetermined nodes in the network, and performing an estimation of communication lines opened in each of the selected one or more paths;
performing an estimation of communication apparatuses constituting the communication line and a housing that accommodates the communication apparatuses, for each node in the network, based on an estimation result of the communication line; and
determining whether there is a possibility of reduction in the number of the housings due to a change in the communication line, for each node in the network, based on respective estimation results of the communication line, the communication apparatus, and the housing,
wherein in the determining of whether there is the possibility of reduction in the number of the housings, when determined that there is the possibility of reduction in the number of the housings, a constraint condition is generated based on a first upper limit number of the communication line that is reduced, for each node,
wherein the estimation of the communication line is performed again according to the constraint condition based on the first upper limit number, and
wherein the estimation of the communication apparatuses and the housing is performed again based on the result of the estimation of the communication line that is performed again.

7. The network design method according to claim 6,
wherein in the determining of whether there is the possibility of reduction in the number of the housings, the estimation of the communication line and the estimation of the communication apparatuses and the housing are repeated until determined that there is no possibility of reduction in the number of the housings, for all nodes in the network.

8. The network design method according to claim 6,
wherein in the determining of whether there is the possibility of reduction in the number of the housings, the possibility of reduction in the number of the housings due to a change in a bandwidth of the communication line is determined.

9. The network design method according to claim 8,
wherein in the determining of whether there is the possibility of reduction in the number of the housings, when an increase amount of cost due to the change in the bandwidth of the communication line exceeds a decrease amount of cost due to a reduction in the number of the housings, the determining determines that there is no possibility of reduction in the number of the housings.

10. The network design method according to claim 6,
wherein in the determining of whether there is the possibility of reduction in the number of the housings, when determined that there is no possibility of reduction in the number of the housings, whether there is a risk of increase in the number of the housings due to re-execution of respective estimations of the communication line, the communication apparatuses, and the housing is determined for the node, and when determined that there is the risk of increase in the number of the housings, a constraint condition is generated based on a second upper limit number of the communication line of not increasing the number of the housings,
wherein the estimation of the communication line is performed again according to the constraint condition based on the second upper limit number, and
wherein the estimation of the communication apparatuses and the housing is performed again, based on a result of the estimation of the communication line that is performed again.

11. A recording medium storing a computer-readable network design program that causes a computer to execute:
determining a communication route that connects predetermined nodes by selecting one or more paths provided between the nodes in a network, in response to traffic demand between the predetermined nodes in the network, and performing an estimation of communication lines opened in each of the selected one or more paths;
performing an estimation of communication apparatuses constituting the communication line and a housing that accommodates the communication apparatuses, for each node in the network, based on an estimation result of the communication line; and
determining whether there is a possibility of reduction in the number of the housings due to a change in the communication line, for each node in the network, based on respective estimation results of the communication line, the communication apparatus, and the housing;
generating a constraint condition based on a first upper limit number of the communication line that is reduced, for each node, when determined that there is the possibility of reduction in the number of the housings, in the determining of whether there is the possibility of reduction in the number of the housings;
performing again the estimation of the communication line according to the constraint condition based on the first upper limit number; and
performing again the estimations of the communication apparatuses and the housing based on the result of the estimation of the communication line that is performed again.

12. The recording medium storing a computer-readable network design program according to claim 11,
wherein in the determining of whether there is the possibility of reduction in the number of the housings, the estimation of the communication line and the estimation of the communication apparatuses and the housing are repeated until determined that there is no possibility of reduction in the number of the housings, for all nodes in the network.

13. The recording medium storing a computer-readable network design program according to claim 11,
wherein in the determining of whether there is the possibility of reduction in the number of the housings, the possibility of reduction in the number of the housings due to a change in a bandwidth of the communication line is determined.

14. The recording medium storing a computer-readable network design program according to claim 13,
wherein in the determining of whether there is the possibility of reduction in the number of the housings, when an increase amount of cost due to the change in the bandwidth of the communication line exceeds a decrease amount of cost due to a reduction in the number of the housings, the determining determines that there is no possibility of reduction in the number of the housings.

15. The recording medium storing a computer-readable network design program according to claim 11,
wherein in the determining of whether there is the possibility of reduction in the number of the housings, when determined that there is no possibility of reduction in the number of the housings, whether there is a risk of increase in the number of the housings due to re-execution of respective estimations of the communication line, the communication apparatus, and the housing is determined for the node, and when determined that there is the risk of increase in the number of the housings, a constraint condition is generated based on a second upper limit number of the communication line of not increasing the number of the housings,
wherein the estimation of the communication line is performed again according to the constraint condition based on the second upper limit number, and
wherein the estimation of the communication apparatuses and the housing is performed again, based on a result of the estimation of the communication line that is performed again.
